(19) United States
(12) Patent Application Publication
(10) Pub. No.: US 2025/0283985 A1
(43) Pub. Date: Sep. 11, 2025

(54) DETERMINING AN AT LEAST PARTIALLY ASBORBING BLOCKAGE ON A LIDAR SYSTEM

(71) Applicant: Luminar Technologies, Inc., Orlando, FL (US)

(72) Inventor: Prateek Mehrotra, Santa Clara, CA (US)

(21) Appl. No.: 18/600,211

(22) Filed: Mar. 8, 2024

(51) Int. Cl. G01S 7/487; G01S 7/497; G01S 17/93

(52) U.S. Cl. CPC G01S 7/4873; G01S 17/93; G01S 2007/4975

(57) ABSTRACT

In various embodiments, a process includes emitting an output beam through a window, scanning the beam across a field of regard, and detecting pulses of light corresponding to scattered reflection returns of a first part of the emitted pulses. Scattered reflection returns of a second part of the emitted pulses are below a detection threshold. The process includes determining whether at least a portion of the second part of the emitted pulses of light corresponds to a blockage on the window including by clustering projected locations on the window for the second part of the emitted pulses of light, determining an edge of a shape encompassing the cluster(s), and analyzing signal properties of the received pulse(s) of light corresponding to one or more of the first part of the emitted pulses of light that are associated with projected locations within a threshold distance from the edge of the shape.

### BACKGROUND OF THE INVENTION

Light detection and ranging (lidar) is a technology that can be used to measure distances to remote targets. Typically, a lidar system includes a light source and an optical receiver. The light source can include, for example, a laser which emits light having a particular operating wavelength. The operating wavelength of a lidar system may lie, for example, in the infrared, visible, or ultraviolet portions of the electromagnetic spectrum. The light source emits light towards a target which scatters the light, and some of the scattered light is received back at the receiver. The system determines the distance to the target based on one or more characteristics associated with the received light. For example, the lidar system may determine the distance to the target based on the time of flight for a pulse of light emitted by the light source to travel to the target and back to the lidar system. Sometimes, the light source emits light towards a target, but receives no return. This may happen due to a variety of causes. Thus, there is a need to identify a blockage to the lidar system.

### BRIEF DESCRIPTION OF THE DRAWINGS

Various embodiments of the invention are disclosed in the following detailed description and the accompanying drawings.

FIG. 1 illustrates an example light detection and ranging (lidar) system.

FIG. 2 illustrates an example scan pattern produced by a lidar system.

FIG. 3 illustrates an example lidar system with an example rotating polygon mirror.

FIG. 4 illustrates an example light-source field of view (FOV_{L}) and receiver field of view (FOV_{R}) for a lidar system.

FIG. 5 illustrates an example unidirectional scan pattern that includes multiple pixels and multiple scan lines.

FIG. 6 illustrates an example light detection and ranging (lidar) system including a blockage.

FIG. 7 is a flow diagram illustrating an embodiment of a process for determining a lidar blockage.

FIG. 8 is a flow diagram illustrating an embodiment of a process for determining whether emitted pulses correspond to a blockage on a window.

FIG. 9 is a flow diagram illustrating an embodiment of a process for analyzing signal properties of one or more of the received pulses of light.

FIG. 10 shows an example of a point cloud corresponding to a clean sensor. In this example, the darkness of the points represents the distance to a target.

FIG. 11 shows an example of a point cloud corresponding to a sensor with a blockage.

FIG. 12 shows an example of a blockage map corresponding to a sensor with a blockage.

FIG. 13A shows an example of a blockage map including an identified concave hull corresponding to a sensor with a blockage.

FIG. 13B shows an example of a blockage map including identified neighbors of edge points in a concave hull corresponding to a sensor with a blockage.

FIG. 13C shows an example of a blockage map including a determined cluster blockage level of a concave hull corresponding to a sensor with a blockage.

FIG. 14 illustrates an example computer system.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications, and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques for determining a lidar blockage are disclosed. In various embodiments, a cause of a lidar blockage may be determined using techniques for blockage affiliated segregation of empty returns via clusters and hulls. An output beam comprising pulses of light is emitted through a window (decorative glass) of a lidar system. The output beam is scanned across a field of regard of the system. Returns are received. The returns may include pulses of light corresponding to scattered reflection returns of a first part of the emitted pulses of light. The scattered reflection returns, if any, of a second part of the emitted pulses of light are below a detection threshold of the receiver. A blockage on the window is determined based on the second part of the emitted pulses of light including by clustering projected locations on the window for the second part of the emitted pulses of light into one or more clusters. The edge (hull) of a shape encompassing at least one of the clusters is determined. The signal properties of one or more of the received pulses of light corresponding to one or more of the first part of the emitted pulses of light that are associated with projected locations on the window within a threshold distance from the edge of the shape may be analyzed as follows. A corresponding blockage level for each edge point of a plurality of edge points associated with the edge of the shape is determined. An average of the corresponding blockage levels of the plurality of edge points is determined, and a cluster blockage level is assigned to the cluster associated with the edge of the shape. If the cluster blockage level of the cluster is below a cluster blockage level threshold, then the cluster is considered to be a benign blockage because it is not primarily due to a blockage on the window. A blockage level may also be due to a combination of light blockage (e.g., rain) on the window and external environmental loss (e.g., a glass pane). In other words, the blockage level is based on the effect of a light absorbing blockage superimposed with real world loss. In either case, the empty returns may be primarily caused by free space loss or a puddle on the ground. Otherwise, if the cluster blockage level is above the threshold, then the cluster is considered to be due to a malignant blockage because it is primarily due to a blockage on the window such as dirty water spray.

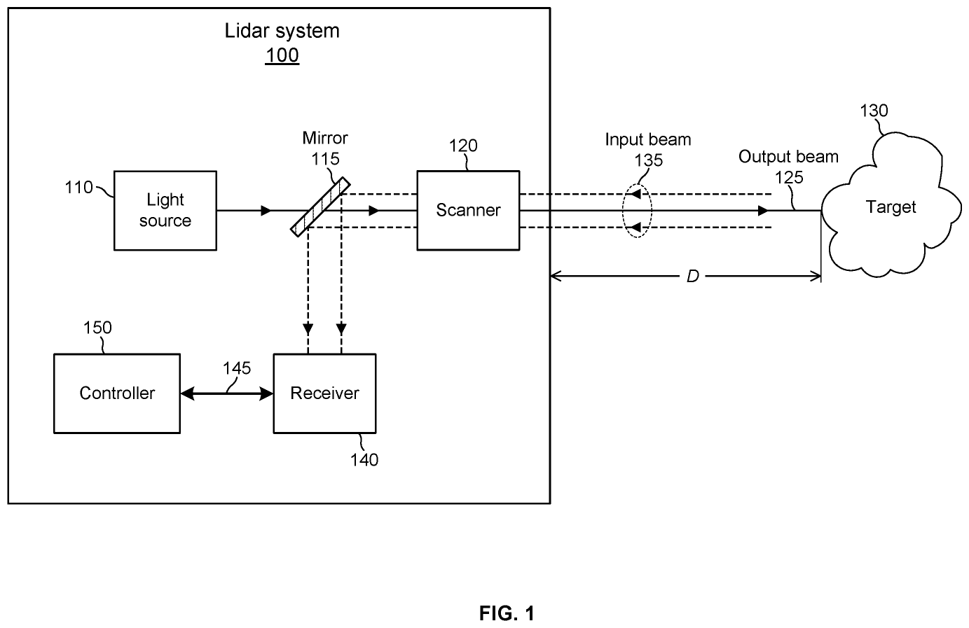

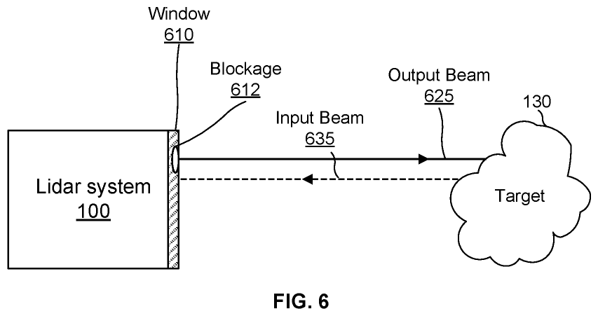

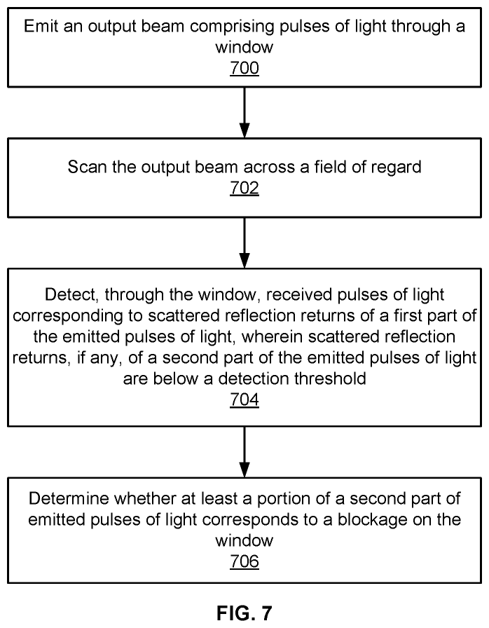

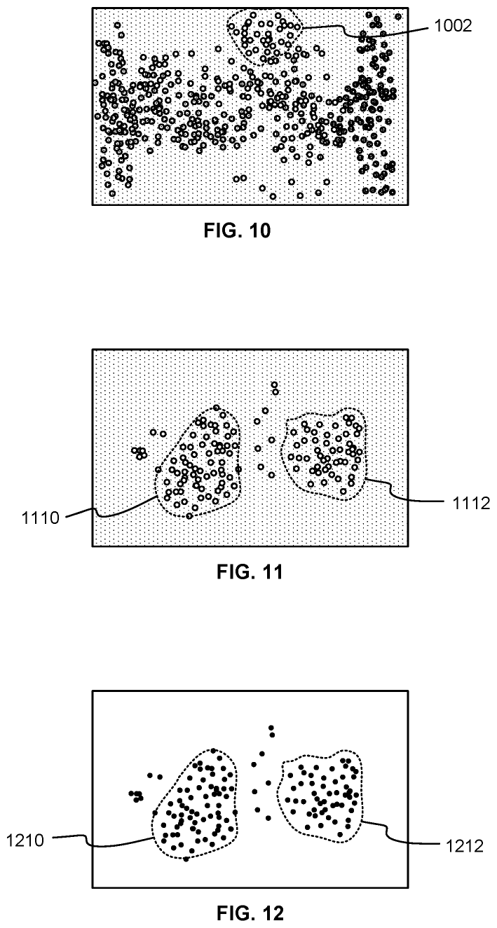

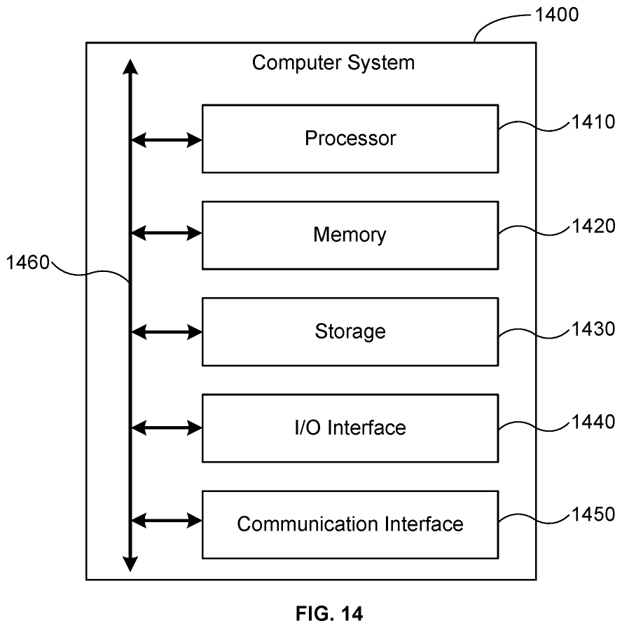

FIGS. 1-5 describe an example of a lidar system for which causes of blockages may be detected. FIG. 6 shows an example of a blockage to a lidar system. FIGS. 7-9 describe an example of a process for determining a cause of a lidar blockage. FIGS. 10-13C show examples of point clouds. FIG. 14 shows an example of a computer system configured to determine a lidar blockage.

FIG. 1 illustrates an example light detection and ranging (lidar) system 100. A lidar system 100 may be referred to as a laser ranging system, a laser radar system, a LIDAR system, a lidar sensor, or a laser detection and ranging (LADAR or ladar) system. A lidar system 100 may include a light source 110, mirror 115, scanner 120, receiver 140, or controller 150 (which may be referred to as a processor). The light source 110 may include, for example, a laser which emits light having a particular operating wavelength in the infrared, visible, or ultraviolet portions of the electromagnetic spectrum. As an example, light source 110 may include a laser with one or more operating wavelengths between approximately 900 nanometers (nm) and 2000 nm. The light source 110 emits an output beam of light 125 which may be continuous wave (CW), pulsed, or modulated in any suitable manner for a given application. The output beam of light 125 is directed downrange toward a remote target 130. The emitted light passes through a window before reaching any downrange targets or object. The window is used at least in part to protect the lidar system, for example, from environmental elements such as road debris and weather, as further described herein with respect to FIG. 6. As an example, the remote target 130 may be located a distance D of approximately 1 m to 1 km from the lidar system 100.

Once the output beam 125 reaches the downrange target 130, the target may scatter or reflect at least a portion of light from the output beam 125, and some of the scattered or reflected light may return toward the lidar system 100. In the example of FIG. 1, the scattered or reflected light is represented by input beam 135, which passes through scanner 120 and is reflected by mirror 115 and directed to receiver 140. A relatively small fraction of the light from output beam 125 may return to the lidar system 100 as input beam 135. As an example, the ratio of input beam 135 average power, peak power, or pulse energy to output beam 125 average power, peak power, or pulse energy may be approximately 10⁻¹, 10⁻², 10⁻³, 10⁻⁴, 10⁻⁵, 10⁻⁶, 10⁻⁷, 10⁻⁸, 10⁻⁹, 10⁻¹⁰, 10⁻¹¹, or 10⁻¹². As another example, if a pulse of light of output beam 125 has a pulse energy of 1 microjoule (μJ), then the pulse energy of a corresponding pulse of input beam 135 may have a pulse energy of approximately 10 nanojoules (nJ), 1 nJ, 100 picojoules (pJ), 10 pJ, 1 pJ, 100 femtojoules (fJ), 10 fJ, 1 fJ, 100 attojoules (aJ), 10 aJ, 1 aJ, or 0.1 aJ.

The output beam 125 may include or may be referred to as an optical signal, output optical signal, emitted optical signal, output light, emitted pulse of light, laser beam, light beam, optical beam, emitted beam, transmitted beam of light, emitted light, or beam. The input beam 135 may include or may be referred to as a received optical signal, received pulse of light, input pulse of light, input optical signal, return beam, received beam, received beam of light, return light, received light, input light, scattered light, or reflected light. As used herein, scattered light may refer to light that is scattered or reflected by a target 130. As an example, an input beam 135 may include: light from the output beam 125 that is scattered by target 130; light from the output beam 125 that is reflected by target 130; or a combination of scattered and reflected light from target 130.

A receiver 140 may receive or detect photons from input beam 135 and produce one or more representative electrical signals. For example, the receiver 140 may produce an output electrical signal 145 that is representative of the input beam 135, and the electrical signal 145 may be sent to controller 150. A receiver 140 or controller 150 may include a processor, a computer system, an ASIC, an FPGA, or other suitable computing circuitry. A controller 150 may be configured to analyze one or more characteristics of the electrical signal 145 from the receiver 140 to determine one or more characteristics of the target 130, such as its distance downrange from the lidar system 100. This may be done, for example, by analyzing a time of flight or a frequency or phase of a transmitted beam of light 125 or a received beam of light 135. If lidar system 100 measures a time of flight of T (e.g., T may represent a round-trip time of flight for an emitted pulse of light to travel from the lidar system 100 to the target 130 and back to the lidar system 100), then the distance D from the target 130 to the lidar system 100 may be expressed as D=c·T/2, where c is the speed of light (approximately 3.0×10⁸ m/s). As an example, if a time of flight is measured to be T=300 ns, then the distance from the target 130 to the lidar system 100 may be determined to be approximately D=45.0 m. As another example, if a time of flight is measured to be T=1.33 μs, then the distance from the target 130 to the lidar system 100 may be determined to be approximately D=199.5 m. A distance D from lidar system 100 to a target 130 may be referred to as a distance, depth, or range of target 130. As used herein, the speed of light c refers to the speed of light in any suitable medium, such as for example in air, water, or vacuum. As an example, the speed of light in vacuum is approximately 2.9979×10⁸ m/s, and the speed of light in air (which has a refractive index of approximately 1.0003) is approximately 2.9970×10⁸ m/s.

A light source 110 may include a pulsed or CW laser. As an example, light source 110 may be a pulsed laser configured to produce or emit pulses of light with a pulse duration or pulse width of approximately 10 picoseconds (ps) to 100 nanoseconds (ns). The pulses may have a pulse duration of approximately 100 ps, 200 ps, 400 ps, 1 ns, 2 ns, 5 ns, 10 ns, 20 ns, 50 ns, 100 ns, or any other suitable pulse duration. As another example, light source 110 may be a pulsed laser that produces pulses of light with a pulse duration of approximately 1-5 ns. As another example, light source 110 may be a pulsed laser that produces pulses of light at a pulse repetition frequency of approximately 100 kHz to 10 MHz or a pulse period (e.g., a time between consecutive pulses of light) of approximately 100 ns to 10 μs. The pulse period t may be related to the pulse repetition frequency (PRF) by the expression τ=1/PRF. For example, a pulse period of 1.33 μs corresponds to a PRF of approximately 752 kHz. Light source 110 may have a substantially constant pulse repetition frequency, or light source 110 may have a variable or adjustable pulse repetition frequency. As an example, light source 110 may be a pulsed laser that produces pulses at a substantially constant pulse repetition frequency of approximately 640 kHz (e.g., 640,000 pulses per second), corresponding to a pulse period of approximately 1.56 μs. As another example, light source 110 may have a pulse repetition frequency (which may be referred to as a repetition rate) that can be varied from approximately 200 kHz to 3 MHz. As used herein, a pulse of light may be referred to as an optical pulse, a light pulse, or a pulse.

A light source 110 may include a pulsed or CW laser that produces a free-space output beam 125 having any suitable average optical power. As an example, output beam 125 may have an average power of approximately 1 milliwatt (mW), 10 mW, 100 mW, 1 watt (W), 10 W, or any other suitable average power. An output beam 125 may include optical pulses with any suitable pulse energy or peak optical power. As an example, output beam 125 may include pulses with a pulse energy of approximately 0.01 μJ, 0.1 μJ, 0.5 μJ, 1 μJ, 2 μJ, 10 μJ, or 100 μJ, or any other suitable pulse energy. As another example, output beam 125 may include pulses with a peak power of approximately 10 W, 100 W, 1 kW, 5 KW, 10 kW, or any other suitable peak power. The peak power (Pₚₑₐₖ) of a pulse of light can be related to the pulse energy (E) by the expression E=Pₚₑₐₖ·Δt, where Δt is the duration of the pulse, and the duration of a pulse may be defined as the full width at half maximum duration of the pulse. For example, an optical pulse with a duration of 1 ns and a pulse energy of 1 μJ has a peak power of approximately 1 kW. The average power (Pₐᵥ) of an output beam 125 can be related to the pulse repetition frequency (PRF) and pulse energy by the expression Pₐᵥ=PRF·E. For example, if the pulse repetition frequency is 500 kHz, then the average power of an output beam 125 with 1-μJ pulses is approximately 0.5 W.

A light source 110 may include a laser diode, such as for example, a Fabry-Perot laser diode, a quantum well laser, a distributed Bragg reflector (DBR) laser, a distributed feedback (DFB) laser, a vertical-cavity surface-emitting laser (VCSEL), a quantum dot laser diode, a grating-coupled surface-emitting laser (GCSEL), a slab-coupled optical waveguide laser (SCOWL), a single-transverse-mode laser diode, a multi-mode broad area laser diode, a laser-diode bar, a laser-diode stack, or a tapered-stripe laser diode. As an example, light source 110 may include an aluminum-gallium-arsenide (AlGaAs) laser diode, an indium-gallium-arsenide (InGaAs) laser diode, an indium-gallium-arsenide-phosphide (InGaAsP) laser diode, or a laser diode that includes any suitable combination of aluminum (Al), indium (In), gallium (Ga), arsenic (As), phosphorous (P), or any other suitable material. A light source 110 may include a pulsed or CW laser diode with a peak emission wavelength between 1200 nm and 1600 nm. As an example, light source 110 may include a current-modulated InGaAsP DFB laser diode that produces optical pulses at a wavelength of approximately 1550 nm. As another example, light source 110 may include a laser diode that emits light at a wavelength between 1500 nm and 1510 nm.

A light source 110 may include a pulsed or CW laser diode followed by one or more optical-amplification stages. For example, a seed laser diode may produce a seed optical signal, and an optical amplifier may amplify the seed optical signal to produce an amplified optical signal that is emitted by the light source 110. An optical amplifier may include a fiber-optic amplifier or a semiconductor optical amplifier (SOA). For example, a pulsed laser diode may produce relatively low-power optical seed pulses which are amplified by a fiber-optic amplifier. As another example, a light source 110 may include a fiber-laser module that includes a current-modulated laser diode with an operating wavelength of approximately 1550 nm followed by a single-stage or a multi-stage erbium-doped fiber amplifier (EDFA) or erbium-ytterbium-doped fiber amplifier (EYDFA) that amplifies the seed pulses from the laser diode. As another example, light source 110 may include a continuous-wave (CW) or quasi-CW laser diode followed by an external optical modulator (e.g., an electro-optic amplitude modulator). The optical modulator may modulate the CW light from the laser diode to produce optical pulses which are sent to a fiber-optic amplifier or SOA. As another example, light source 110 may include a pulsed or CW seed laser diode followed by a semiconductor optical amplifier (SOA). The SOA may include an active optical waveguide configured to receive light from the seed laser diode and amplify the light as it propagates through the waveguide. The optical gain of the SOA may be provided by pulsed or direct-current (DC) electrical current supplied to the SOA. The SOA may be integrated on the same chip as the seed laser diode, or the SOA may be a separate device with an anti-reflection coating on its input facet or output facet. As another example, light source 110 may include a seed laser diode followed by a SOA, which in turn is followed by a fiber-optic amplifier. For example, the seed laser diode may produce relatively low-power seed pulses which are amplified by the SOA, and the fiber-optic amplifier may further amplify the optical pulses.

A light source 110 may include a direct-emitter laser diode. A direct-emitter laser diode (which may be referred to as a direct emitter) may include a laser diode which produces light that is not subsequently amplified by an optical amplifier. A light source 110 that includes a direct-emitter laser diode may not include an optical amplifier, and the output light produced by a direct emitter may not be amplified after it is emitted by the laser diode. The light produced by a direct-emitter laser diode (e.g., optical pulses, CW light, or frequency-modulated light) may be emitted directly as a free-space output beam 125 without being amplified. A direct-emitter laser diode may be driven by an electrical power source that supplies current pulses to the laser diode, and each current pulse may result in the emission of an output optical pulse.

A light source 110 may include a diode-pumped solid-state (DPSS) laser. A DPSS laser (which may be referred to as a solid-state laser) may refer to a laser that includes a solid-state, glass, ceramic, or crystal-based gain medium that is pumped by one or more pump laser diodes. The gain medium may include a host material that is doped with rare-earth ions (e.g., neodymium, erbium, ytterbium, or praseodymium). For example, a gain medium may include a yttrium aluminum garnet (YAG) crystal that is doped with neodymium (Nd) ions, and the gain medium may be referred to as a Nd:YAG crystal. A DPSS laser with a Nd:YAG gain medium may produce light at a wavelength between approximately 1300 nm and approximately 1400 nm, and the Nd:YAG gain medium may be pumped by one or more pump laser diodes with an operating wavelength between approximately 730 nm and approximately 900 nm. A DPSS laser may be a passively Q-switched laser that includes a saturable absorber (e.g., a vanadium-doped crystal that acts as a saturable absorber). Alternatively, a DPSS laser may be an actively Q-switched laser that includes an active Q-switch (e.g., an acousto-optic modulator or an electro-optic modulator). A passively or actively Q-switched DPSS laser may produce output optical pulses that form an output beam 125 of a lidar system 100.

An output beam of light 125 emitted by light source 110 may be unpolarized or randomly polarized, may have no specific or fixed polarization (e.g., the polarization may vary with time), or may have a particular polarization (e.g., output beam 125 may be linearly polarized, elliptically polarized, or circularly polarized). As an example, light source 110 may produce light with no specific polarization or may produce light that is linearly polarized.

A lidar system 100 may include one or more optical components configured to reflect, focus, filter, shape, modify, steer, or direct light within the lidar system 100 or light produced or received by the lidar system 100 (e.g., output beam 125 or input beam 135). As an example, lidar system 100 may include one or more lenses, mirrors, filters (e.g., band-pass or interference filters), beam splitters, optical splitters, polarizers, polarizing beam splitters, wave plates (e.g., half-wave or quarter-wave plates), diffractive elements, holographic elements, isolators, couplers, detectors, beam combiners, or collimators. The optical components in a lidar system 100 may be free-space optical components, fiber-coupled optical components, or a combination of free-space and fiber-coupled optical components.

A lidar system 100 may include a telescope, one or more lenses, or one or more mirrors configured to expand, focus, collimate, or steer the output beam 125 or the input beam 135 to a desired beam diameter or divergence. As an example, the lidar system 100 may include one or more lenses to focus the input beam 135 onto a photodetector of receiver 140. As another example, the lidar system 100 may include one or more flat mirrors or curved mirrors (e.g., concave, convex, or parabolic mirrors) to steer or focus the output beam 125 or the input beam 135. For example, the lidar system 100 may include an off-axis parabolic mirror to focus the input beam 135 onto a photodetector of receiver 140. As illustrated in FIG. 1, the lidar system 100 may include mirror 115 (which may be a metallic or dielectric mirror), and mirror 115 may be configured so that light beam 125 passes through the mirror 115 or passes along an edge or side of the mirror 115 and input beam 135 is reflected toward the receiver 140. As an example, mirror 115 (which may be referred to as an overlap mirror, superposition mirror, or beam-combiner mirror) may include a hole, slot, or aperture which output light beam 125 passes through. As another example, rather than passing through the mirror 115, the output beam 125 may be directed to pass alongside the mirror 115 with a gap (e.g., a gap of width approximately 0.1 mm, 0.5 mm, 1 mm, 2 mm, 5 mm, or 10 mm) between the output beam 125 and an edge of the mirror 115.

The mirror 115 may provide for output beam 125 and input beam 135 to be substantially coaxial so that the two beams travel along approximately the same optical path (albeit in opposite directions). The input and output beams being substantially coaxial may refer to the beams being at least partially overlapped or sharing a common propagation axis so that input beam 135 and output beam 125 travel along substantially the same optical path (albeit in opposite directions). As an example, output beam 125 and input beam 135 may be parallel to each other to within less than 10 mrad, 5 mrad, 2 mrad, 1 mrad, 0.5 mrad, or 0.1 mrad. As output beam 125 is scanned across a field of regard, the input beam 135 may follow along with the output beam 125 so that the coaxial relationship between the two beams is maintained.

A lidar system 100 may include a scanner 120 configured to scan an output beam 125 across a field of regard of the lidar system 100. As an example, scanner 120 may include one or more scan mirrors configured to pivot, rotate, oscillate, or move in an angular manner about one or more rotation axes. The output beam 125 may be reflected by a scan mirror, and as the scan mirror pivots or rotates, the reflected output beam 125 may be scanned in a corresponding angular manner. As an example, a scan mirror may be configured to periodically pivot back and forth over a 30-degree range, which results in the output beam 125 scanning back and forth across a 60-degree range (e.g., a Θ-degree rotation by a scan mirror results in a 2Θ-degree angular scan of output beam 125).

A scan mirror (which may be referred to as a scanning mirror) may be attached to or mechanically driven by a scanner actuator or mechanism which pivots or rotates the mirror over a particular angular range (e.g., over a 5° angular range, 30° angular range, 60° angular range, 120° angular range, 360° angular range, or any other suitable angular range). A scanner actuator or mechanism configured to pivot or rotate a mirror may include a galvanometer scanner, a resonant scanner, a piezoelectric actuator, a voice coil motor, an electric motor (e.g., a DC motor, a brushless DC motor, a synchronous electric motor, or a stepper motor), a microelectromechanical systems (MEMS) device, or any other suitable actuator or mechanism. As an example, a scanner 120 may include a scan mirror attached to a galvanometer scanner configured to pivot back and forth over a 1° to 30° angular range. As another example, a scanner 120 may include a scan mirror that is attached to or is part of a MEMS device configured to scan over a 1° to 30° angular range. As another example, a scanner 120 may include a polygon mirror configured to rotate continuously in the same direction (e.g., rather than pivoting back and forth, the polygon mirror continuously rotates 360 degrees in a clockwise or counterclockwise direction). The polygon mirror may be coupled or attached to a synchronous motor configured to rotate the polygon mirror at a substantially fixed rotational frequency (e.g., a rotational frequency of approximately 1 Hz, 10 Hz, 50 Hz, 100 Hz, 500 Hz, or 1,000 Hz).

A scanner 120 may be configured to scan an output beam 125 (which may include at least a portion of the light emitted by light source 110) across a field of regard of a lidar system 100. A field of regard (FOR) of a lidar system 100 may refer to an area, region, or angular range over which the lidar system 100 may be configured to scan or capture distance information. As an example, a lidar system 100 with an output beam 125 with a 30-degree scanning range may be referred to as having a 30-degree angular field of regard. As another example, a lidar system 100 with a scan mirror that rotates over a 30-degree range may produce an output beam 125 that scans across a 60-degree range (e.g., a 60-degree FOR). A lidar system 100 may have a FOR of approximately 10°, 20°, 40°, 60°, 120°, 360°, or any other suitable FOR.

A scanner 120 may be configured to scan an output beam 125 horizontally and vertically, and lidar system 100 may have a particular FOR along the horizontal direction and another particular FOR along the vertical direction. As an example, lidar system 100 may have a horizontal FOR of 10° to 120° and a vertical FOR of 2° to 45°. A scanner 120 may include a first scan mirror and a second scan mirror, where the first scan mirror directs the output beam 125 toward the second scan mirror, and the second scan mirror directs the output beam 125 downrange from the lidar system 100. As an example, the first scan mirror may scan the output beam 125 along a first direction, and the second scan mirror may scan the output beam 125 along a second direction that is different from the first direction (e.g., the first and second directions may be approximately orthogonal to one another, or the second direction may be oriented at any suitable non-zero angle with respect to the first direction). As another example, the first scan mirror may scan the output beam 125 along a substantially horizontal direction, and the second scan mirror may scan the output beam 125 along a substantially vertical direction (or vice versa). As another example, the first and second scan mirrors may each be driven by galvanometer scanners. As another example, the first or second scan mirror may include a polygon mirror driven by an electric motor. A scanner 120 may be referred to as a beam scanner, optical scanner, or laser scanner.

One or more scan mirrors may be communicatively coupled to a controller 150 which may control the scan mirror(s) so as to guide the output beam 125 in a desired direction downrange or along a desired scan pattern. A scan pattern may refer to a pattern or path along which the output beam 125 is directed. As an example, scanner 120 may include two scan mirrors configured to scan the output beam 125 across a 60° horizontal FOR and a 20° vertical FOR. The two scan mirrors may be controlled to follow a scan path that substantially covers the 60°×20° FOR. As an example, the scan path may result in a point cloud with pixels that substantially cover the 60°×20° FOR. The pixels may be approximately evenly distributed across the 60°×20° FOR. Alternatively, the pixels may have a particular nonuniform distribution (e.g., the pixels may be distributed across all or a portion of the 60°×20° FOR, and the pixels may have a higher density in one or more particular regions of the 60°×20° FOR).

A lidar system 100 may include a scanner 120 with a solid-state scanning device. A solid-state scanning device may refer to a scanner 120 that scans an output beam 125 without the use of moving parts (e.g., without the use of a mechanical scanner, such as a mirror that rotates or pivots). For example, a solid-state scanner 120 may include one or more of the following: an optical phased array scanning device; a liquid-crystal scanning device; or a liquid lens scanning device. A solid-state scanner 120 may be an electrically addressable device that scans an output beam 125 along one axis (e.g., horizontally) or along two axes (e.g., horizontally and vertically). A scanner 120 may include a solid-state scanner and a mechanical scanner. For example, a scanner 120 may include an optical phased array scanner configured to scan an output beam 125 in one direction and a galvanometer scanner that scans the output beam 125 in an approximately orthogonal direction. The optical phased array scanner may scan the output beam relatively rapidly in a horizontal direction across the field of regard (e.g., at a scan rate of 50 to 1,000 scan lines per second), and the galvanometer may pivot a mirror at a rate of 1-30 Hz to scan the output beam 125 vertically.

A lidar system 100 may include a light source 110 configured to emit pulses of light and a scanner 120 configured to scan at least a portion of the emitted pulses of light across a field of regard of the lidar system 100. One or more of the emitted pulses of light may be scattered by a target 130 located downrange from the lidar system 100, and a receiver 140 may detect at least a portion of the pulses of light scattered by the target 130. A receiver 140 may include or may be referred to as a photoreceiver, optical receiver, optical sensor, detector, photodetector, or optical detector. A lidar system 100 may include a receiver 140 that receives or detects at least a portion of input beam 135 and produces an electrical signal that corresponds to input beam 135. As an example, if input beam 135 includes an optical pulse, then receiver 140 may produce an electrical current or voltage pulse that corresponds to the optical pulse detected by receiver 140. As another example, receiver 140 may include one or more avalanche photodiodes (APDs) or one or more single-photon avalanche diodes (SPADs). As another example, receiver 140 may include one or more PN photodiodes (e.g., a photodiode structure formed by a p-type semiconductor and a n-type semiconductor, where the PN acronym refers to the structure having p-doped and n-doped regions) or one or more PIN photodiodes (e.g., a photodiode structure formed by an undoped intrinsic semiconductor region located between p-type and n-type regions, where the PIN acronym refers to the structure having p-doped, intrinsic, and n-doped regions). An APD, SPAD, PN photodiode, or PIN photodiode may each be referred to as a detector, photodetector, or photodiode. A detector may receive an input beam 135 that includes an optical pulse, and the detector may produce a pulse of electrical current that corresponds to the received optical pulse. A detector may have an active region or an avalanche-multiplication region that includes silicon, germanium, InGaAs, indium aluminum arsenide (InAlAs), InAsSb (indium arsenide antimonide), AlAsSb (aluminum arsenide antimonide), AlInAsSb (aluminum indium arsenide antimonide), or silicon germanium (SiGe). The active region may refer to an area over which a detector may receive or detect input light. An active region may have any suitable size or diameter, such as for example, a diameter of approximately 10 μm, 25 μm, 50 μm, 80 μm, 100 μm, 200 μm, 500 μm, 1 mm, 2 mm, or 5 mm.

A receiver 140 may include electronic circuitry that performs signal amplification, sampling, filtering, signal conditioning, analog-to-digital conversion, time-to-digital conversion, pulse detection, threshold detection, rising-edge detection, or falling-edge detection. As an example, receiver 140 may include a transimpedance amplifier that converts a photocurrent (e.g., a pulse of current produced by an APD in response to a received optical pulse) into a voltage signal. The voltage signal may be sent to pulse-detection circuitry that produces an analog or digital output signal 145 that corresponds to one or more optical characteristics (e.g., rising edge, falling edge, amplitude, duration, or energy) of a received optical pulse. As an example, the pulse-detection circuitry may perform a time-to-digital conversion to produce a digital output signal 145. The electrical output signal 145 may be sent to controller 150 for processing or analysis (e.g., to determine a time-of-flight value corresponding to a received optical pulse).

A controller 150 (which may include or may be referred to as a processor, an FPGA, an ASIC, a computer, or a computing system) may be located within a lidar system 100 or outside of a lidar system 100. Alternatively, one or more parts of a controller 150 may be located within a lidar system 100, and one or more other parts of a controller 150 may be located outside a lidar system 100. One or more parts of a controller 150 may be located within a receiver 140 of a lidar system 100, and one or more other parts of a controller 150 may be located in other parts of the lidar system 100. For example, a receiver 140 may include an FPGA or ASIC configured to process an output electrical signal from the receiver 140, and the processed signal may be sent to another computing system located elsewhere within the lidar system 100 or outside the lidar system 100. A controller 150 may include any suitable arrangement or combination of logic circuitry, analog circuitry, or digital circuitry.

A controller 150 may be electrically coupled or communicatively coupled to light source 110, scanner 120, or receiver 140. As an example, controller 150 may receive electrical trigger pulses or edges from light source 110, where each pulse or edge corresponds to the emission of an optical pulse by light source 110. As another example, controller 150 may provide instructions, a control signal, or a trigger signal to light source 110 indicating when light source 110 should produce optical pulses. Controller 150 may send an electrical trigger signal that includes electrical pulses, where each electrical pulse results in the emission of an optical pulse by light source 110. The frequency, period, duration, pulse energy, peak power, average power, or wavelength of the optical pulses produced by light source 110 may be adjusted based on instructions, a control signal, or trigger pulses provided by controller 150. A controller 150 may be coupled to light source 110 and receiver 140, and the controller 150 may determine a time-of-flight value for an optical pulse based on timing information associated with a time when the pulse was emitted by light source 110 and a time when a portion of the pulse (e.g., input beam 135) was detected or received by receiver 140. A controller 150 may include circuitry that performs signal amplification, sampling, filtering, signal conditioning, analog-to-digital conversion, time-to-digital conversion, pulse detection, threshold detection, rising-edge detection, or falling-edge detection.

A lidar system 100 may include one or more processors (e.g., a controller 150) configured to determine a distance D from the lidar system 100 to a target 130 based at least in part on a round-trip time of flight for an emitted pulse of light to travel from the lidar system 100 to the target 130 and back to the lidar system 100. The target 130 may be at least partially contained within a field of regard of the lidar system 100 and located a distance D from the lidar system 100 that is less than or equal to an operating range (R_{OP}) of the lidar system 100. An operating range (which may be referred to as an operating distance) of a lidar system 100 may refer to a distance over which the lidar system 100 is configured to sense or identify targets 130 located within a field of regard of the lidar system 100. The operating range of lidar system 100 may be any suitable distance, such as for example, 25 m, 50 m, 100 m, 200 m, 250 m, 500 m, or 1 km. As an example, a lidar system 100 with a 200-m operating range may be configured to sense or identify various targets 130 located up to 200 m away from the lidar system 100.

A lidar system 100 may be used to determine the distance to one or more downrange targets 130. By scanning the lidar system 100 across a field of regard, the system may be used to map the distance to a number of points within the field of regard. Each of these depth-mapped points may be referred to as a pixel or a voxel. A collection of pixels captured in succession (which may be referred to as a depth map, a point cloud, or a frame) may be rendered as an image or may be analyzed to identify or detect objects or to determine a shape or distance of objects within the FOR. Some examples of point clouds are shown in FIGS. 10A-11B. As an example, a point cloud may cover a field of regard that extends 60° horizontally and 15° vertically, and the point cloud may include a frame of 100-2000 pixels in the horizontal direction by 4-400 pixels in the vertical direction.

A lidar system 100 may be configured to repeatedly capture or generate point clouds of a field of regard at any suitable frame rate between approximately 0.1 frames per second (FPS) and approximately 1,000 FPS. As an example, lidar system 100 may generate point clouds at a frame rate of approximately 0.1 FPS, 0.5 FPS, 1 FPS, 2 FPS, 5 FPS, 10 FPS, 20 FPS, 100 FPS, 500 FPS, or 1,000 FPS. As another example, lidar system 100 may be configured to produce optical pulses at a rate of 5×10⁵ pulses/second (e.g., the system may determine 500,000 pixel distances per second) and scan a frame of 1000×50 pixels (e.g., 50,000 pixels/frame), which corresponds to a point-cloud frame rate of 10 frames per second (e.g., 10 point clouds per second). A point-cloud frame rate may be substantially fixed, or a point-cloud frame rate may be dynamically adjustable. As an example, a lidar system 100 may capture one or more point clouds at a particular frame rate (e.g., 1 Hz) and then switch to capture one or more point clouds at a different frame rate (e.g., 10 Hz). A slower frame rate (e.g., 1 Hz) may be used to capture one or more high-resolution point clouds, and a faster frame rate (e.g., 10 Hz) may be used to rapidly capture multiple lower-resolution point clouds.

A lidar system 100 may be configured to sense, identify, or determine distances to one or more targets 130 within a field of regard. As an example, a lidar system 100 may determine a distance to a target 130, where all or part of the target 130 is contained within a field of regard of the lidar system 100. All or part of a target 130 being contained within a FOR of the lidar system 100 may refer to the FOR overlapping, encompassing, or enclosing at least a portion of the target 130. A target 130 may include all or part of an object that is moving or stationary relative to lidar system 100. As an example, target 130 may include all or a portion of a person, vehicle, motorcycle, truck, train, bicycle, wheelchair, pedestrian, animal, road sign, traffic light, lane marking, road-surface marking, parking space, pylon, guard rail, traffic barrier, pothole, railroad crossing, obstacle in or near a road, curb, stopped vehicle on or beside a road, utility pole, house, building, trash can, mailbox, tree, any other suitable object, or any suitable combination of all or part of two or more objects. A target may be referred to as an object.

A lidar system 100 may include a light source 110, scanner 120, and receiver 140 that are packaged together within a single housing, where a housing may refer to a box, case, or enclosure that holds or contains all or part of a lidar system 100. The housing may include a decorative glass or window (not shown), as further described with respect to FIG. 6. As an example, a lidar-system enclosure may contain a light source 110, mirror 115, scanner 120, and receiver 140 of a lidar system 100. Additionally, the lidar-system enclosure may include a controller 150. The lidar-system enclosure may also include one or more electrical connections for conveying electrical power or electrical signals to or from the enclosure. One or more components of a lidar system 100 may be located remotely from a lidar-system enclosure. As an example, all or part of light source 110 may be located remotely from a lidar-system enclosure, and pulses of light produced by the light source 110 may be conveyed to the enclosure via optical fiber. As another example, all or part of a controller 150 may be located remotely from a lidar-system enclosure.

A light source 110 may include an eye-safe laser, or lidar system 100 may be classified as an eye-safe laser system or laser product. An eye-safe laser, laser system, or laser product may refer to a system that includes a laser with an emission wavelength, average power, peak power, peak intensity, pulse energy, beam size, beam divergence, exposure time, or scanned output beam such that emitted light from the system presents little or no possibility of causing damage to a person's eyes. As an example, light source 110 or lidar system 100 may be classified as a Class 1 laser product (as specified by the 60825-1:2014 standard of the International Electrotechnical Commission (IEC)) or a Class I laser product (as specified by Title 21, Section 1040.10 of the United States Code of Federal Regulations (CFR)) that is safe under all conditions of normal use. A lidar system 100 may be an eye-safe laser product (e.g., with a Class 1 or Class I classification) configured to operate at any suitable wavelength between approximately 900 nm and approximately 2100 nm. As an example, lidar system 100 may include a laser with an operating wavelength between approximately 1200 nm and approximately 1400 nm or between approximately 1400 nm and approximately 1600 nm, and the laser or the lidar system 100 may be operated in an eye-safe manner. As another example, lidar system 100 may be an eye-safe laser product that includes a scanned laser with an operating wavelength between approximately 900 nm and approximately 1700 nm. As another example, lidar system 100 may be a Class 1 or Class I laser product that includes a laser diode, fiber laser, or solid-state laser with an operating wavelength between approximately 1200 nm and approximately 1600 nm. As another example, lidar system 100 may have an operating wavelength between approximately 1500 nm and approximately 1510 nm.

One or more lidar systems 100 may be integrated into a vehicle. As an example, a truck may include a single lidar system 100 with a 60-degree to 180-degree horizontal FOR directed towards the front of the truck. As another example, multiple lidar systems 100 may be integrated into a car to provide a complete 360-degree horizontal FOR around the car. As another example, 2-10 lidar systems 100, each system having a 45-degree to 180-degree horizontal FOR, may be combined together to form a sensing system that provides a point cloud covering a 360-degree horizontal FOR. The lidar systems 100 may be oriented so that adjacent FORs have an amount of spatial or angular overlap to allow data from the multiple lidar systems 100 to be combined or stitched together to form a single or continuous 360-degree point cloud. As an example, the FOR of each lidar system 100 may have approximately 1-30 degrees of overlap with an adjacent FOR. A vehicle may refer to a mobile machine configured to transport people or cargo. For example, a vehicle may include a car used for work, commuting, running errands, or transporting people. As another example, a vehicle may include a truck used to transport commercial goods to a store, warehouse, or residence. A vehicle may include, may take the form of, or may be referred to as a car, automobile, motor vehicle, truck, bus, van, trailer, off-road vehicle, farm vehicle, lawn mower, construction equipment, forklift, robot, golf cart, motorhome, taxi, motorcycle, scooter, bicycle, skateboard, train, snowmobile, watercraft (e.g., a ship or boat), aircraft (e.g., a fixed-wing aircraft, helicopter, or dirigible), unmanned aerial vehicle (e.g., a drone), or spacecraft. A vehicle may include an internal combustion engine or an electric motor that provides propulsion for the vehicle.

One or more lidar systems 100 may be included in a vehicle as part of an advanced driver assistance system (ADAS) to assist a driver of the vehicle in operating the vehicle. For example, a lidar system 100 may be part of an ADAS that provides information (e.g., about the surrounding environment) or feedback to a driver (e.g., to alert the driver to potential problems or hazards) or that automatically takes control of part of a vehicle (e.g., a braking system or a steering system) to avoid collisions or accidents. A lidar system 100 may be part of a vehicle ADAS that provides adaptive cruise control, automated braking, automated parking, collision avoidance, alerts the driver to hazards or other vehicles, maintains the vehicle in the correct lane, or provides a warning if an object or another vehicle is located in a blind spot.

One or more lidar systems 100 may be integrated into a vehicle as part of an autonomous-vehicle driving system. As an example, a lidar system 100 may provide information about the surrounding environment to a driving system of an autonomous vehicle. An autonomous-vehicle driving system may be configured to guide the autonomous vehicle through an environment surrounding the vehicle and toward a destination. An autonomous-vehicle driving system may include one or more computing systems that receive information from a lidar system 100 about the surrounding environment, analyze the received information, and provide control signals to the vehicle's driving systems (e.g., steering mechanism, accelerator, brakes, lights, or turn signals). As an example, a lidar system 100 integrated into an autonomous vehicle may provide an autonomous-vehicle driving system with a point cloud every 0.1 seconds (e.g., the point cloud has a 10 Hz update rate, representing 10 frames per second). The autonomous-vehicle driving system may analyze the received point clouds to sense or identify targets 130 and their respective locations, distances, or speeds, and the autonomous-vehicle driving system may update control signals based on this information. As an example, if lidar system 100 detects a vehicle ahead that is slowing down or stopping, the autonomous-vehicle driving system may send instructions to release the accelerator and apply the brakes.

An autonomous vehicle may be referred to as an autonomous car, driverless car, self-driving car, robotic car, or unmanned vehicle. An autonomous vehicle may refer to a vehicle configured to sense its environment and navigate or drive with little or no human input. As an example, an autonomous vehicle may be configured to drive to any suitable location and control or perform all safety-critical functions (e.g., driving, steering, braking, parking) for the entire trip, with the driver not expected to control the vehicle at any time. As another example, an autonomous vehicle may allow a driver to safely turn their attention away from driving tasks in particular environments (e.g., on freeways), or an autonomous vehicle may provide control of a vehicle in all but a few environments, requiring little or no input or attention from the driver.

An autonomous vehicle may be configured to drive with a driver present in the vehicle, or an autonomous vehicle may be configured to operate the vehicle with no driver present. As an example, an autonomous vehicle may include a driver's seat with associated controls (e.g., steering wheel, accelerator pedal, and brake pedal), and the vehicle may be configured to drive with no one seated in the driver's seat or with little or no input from a person seated in the driver's seat. As another example, an autonomous vehicle may not include any driver's seat or associated driver's controls, and the vehicle may perform substantially all driving functions (e.g., driving, steering, braking, parking, and navigating) without human input. As another example, an autonomous vehicle may be configured to operate without a driver (e.g., the vehicle may be configured to transport human passengers or cargo without a driver present in the vehicle). As another example, an autonomous vehicle may be configured to operate without any human passengers (e.g., the vehicle may be configured for transportation of cargo without having any human passengers onboard the vehicle).

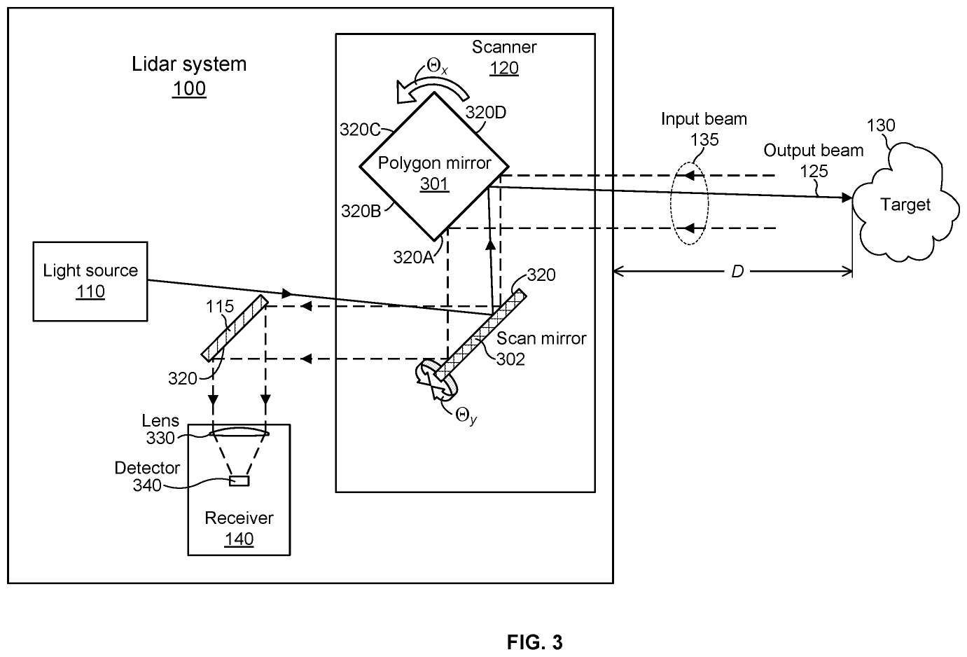

An optical signal (which may be referred to as a light signal, a light waveform, an optical waveform, an output beam, an emitted optical signal, or emitted light) may include pulses of light, CW light, amplitude-modulated light, frequency-modulated (FM) light, or any suitable combination thereof. Although this disclosure describes or illustrates example embodiments of lidar systems 100 or light sources 110 that produce optical signals that include pulses of light, the embodiments described or illustrated herein may also be applied, where appropriate, to other types of optical signals, including continuous-wave (CW) light, amplitude-modulated optical signals, or frequency-modulated optical signals. For example, a lidar system 100 as described or illustrated herein may be a pulsed lidar system and may include a light source 110 that produces pulses of light. The distance to a remote target 130 may be determined based on the round-trip time of flight for a pulse of light to travel to the target 130 and back. Alternatively, a lidar system 100 may be configured to operate as a frequency-modulated continuous-wave (FMCW) lidar system and may include a light source 110 that produces a frequency-modulated optical signal. For example, output beam 125 in FIG. 1 or FIG. 3 may include FM light. Additionally, the light source may also produce local-oscillator (LO) light that is frequency modulated. A FMCW lidar system may use frequency-modulated light to determine the distance to a remote target 130 based on a frequency of received light (which includes emitted light scattered by the remote target) relative to a frequency of the LO light. A round-trip time for the emitted light to travel to a target 130 and back to the lidar system may correspond to a frequency difference between the received scattered light and the LO light. A larger frequency difference may correspond to a longer round-trip time and a greater distance to the target 130. The frequency difference between the received scattered light and the LO light may be referred to as a beat frequency.

A light source 110 for a FMCW lidar system may include (i) a direct-emitter laser diode, (ii) a seed laser diode followed by a SOA, (iii) a seed laser diode followed by a fiber-optic amplifier, or (iv) a seed laser diode followed by a SOA and then a fiber-optic amplifier. A seed laser diode or a direct-emitter laser diode may be operated in a CW manner (e.g., by driving the laser diode with a substantially constant DC current), and a frequency modulation may be provided by an external modulator (e.g., an electro-optic phase modulator may apply a frequency modulation to seed-laser light). Alternatively, a frequency modulation may be produced by applying a current modulation to a seed laser diode or a direct-emitter laser diode. The current modulation (which may be provided along with a DC bias current) may produce a corresponding refractive-index modulation in the laser diode, which results in a frequency modulation of the light emitted by the laser diode. The current-modulation component (and the corresponding frequency modulation) may have any suitable frequency or shape (e.g., piecewise linear, sinusoidal, triangle-wave, or sawtooth). For example, the current-modulation component (and the resulting frequency modulation of the emitted light) may increase or decrease monotonically over a particular time interval. As another example, the current-modulation component may include a triangle or sawtooth wave with an electrical current that increases or decreases linearly over a particular time interval, and the light emitted by the laser diode may include a corresponding frequency modulation in which the optical frequency increases or decreases approximately linearly over the particular time interval. For example, a light source 110 that emits light with a linear frequency change of 200 MHz over a 2-μs time interval may be referred to as having a frequency modulation m of 1014 Hz/s (or, 100 MHz/μs).

In addition to producing frequency-modulated emitted light, a light source 110 may also produce frequency-modulated local-oscillator (LO) light. The LO light may be coherent with the emitted light, and the frequency modulation of the LO light may match that of the emitted light. The LO light may be produced by splitting off a portion of the emitted light prior to the emitted light exiting the lidar system. Alternatively, the LO light may be produced by a seed laser diode or a direct-emitter laser diode that is part of the light source 110. For example, the LO light may be emitted from the back facet of a seed laser diode or a direct-emitter laser diode, or the LO light may be split off from the seed light emitted from the front facet of a seed laser diode. The received light (e.g., emitted light that is scattered by a target 130) and the LO light may each be frequency modulated, with a frequency difference or offset that corresponds to the distance to the target 130. For a linearly chirped light source (e.g., a frequency modulation that produces a linear change in frequency with time), the larger the frequency difference is between the received light and the LO light, the farther away the target 130 is located.

A frequency difference between received light and LO light may be determined by mixing the received light with the LO light (e.g., by coupling the two beams onto a detector so they are coherently mixed together at the detector) and determining the resulting beat frequency. For example, a photocurrent signal produced by an APD may include a beat signal resulting from the coherent mixing of the received light and the LO light, and a frequency of the beat signal may correspond to the frequency difference between the received light and the LO light. The photocurrent signal from an APD (or a voltage signal that corresponds to the photocurrent signal) may be analyzed to determine the frequency of the beat signal. If a linear frequency modulation m (e.g., in units of Hz/s) is applied to a CW laser, then the round-trip time T may be related to the frequency difference Δf between the received scattered light and the LO light by the expression T=Δf/m. Additionally, the distance D from the target 130 to the lidar system 100 may be expressed as D=(Δf/m)·c/2, where c is the speed of light. For example, for a light source 110 with a linear frequency modulation of 10¹⁴ Hz/s, if a frequency difference (between the received scattered light and the LO light) of 33 MHz is measured, then this corresponds to a round-trip time of approximately 330 ns and a distance to the target of approximately 50 meters. As another example, a frequency difference of 133 MHz corresponds to a round-trip time of approximately 1.33 μs and a distance to the target of approximately 200 meters. A receiver or processor of a FMCW lidar system may determine a frequency difference between received scattered light and LO light, and the distance to a target may be determined based on the frequency difference. The frequency difference Δf between received scattered light and LO light corresponds to the round-trip time T (e.g., through the relationship T=Δf/m), and determining the frequency difference may correspond to or may be referred to as determining the round-trip time.

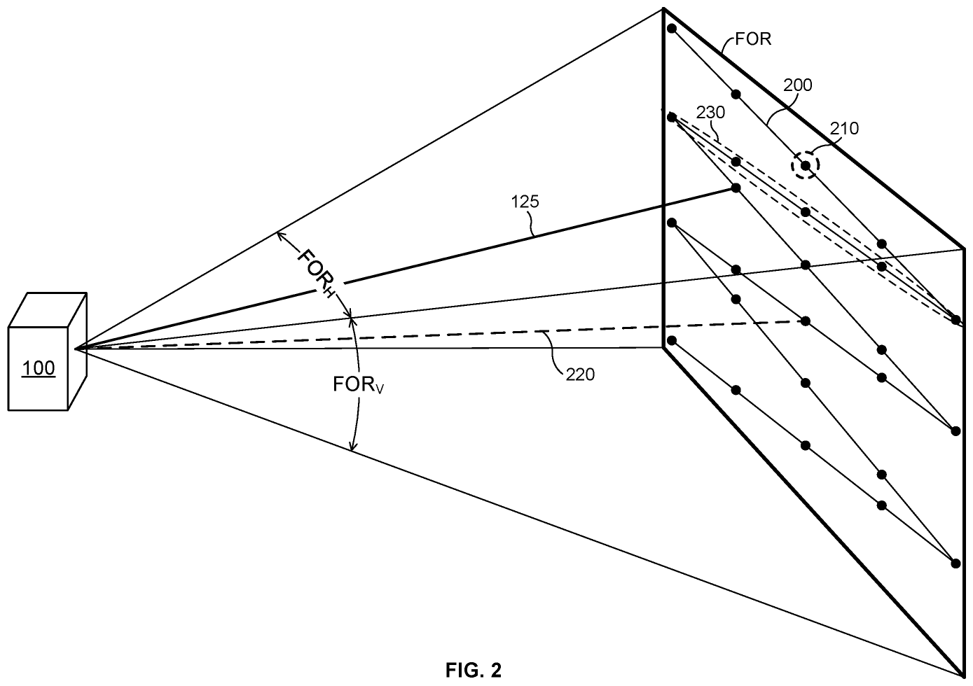

FIG. 2 illustrates an example scan pattern 200 produced by a lidar system 100. A scanner 120 of the lidar system 100 may scan the output beam 125 (which may include multiple emitted optical signals) along a scan pattern 200 that is contained within a field of regard (FOR) of the lidar system 100. A scan pattern 200 (which may be referred to as an optical scan pattern, optical scan path, scan path, or scan) may represent a path or course followed by output beam 125 as it is scanned across all or part of a FOR. Each traversal of a scan pattern 200 by the output beam 125 may correspond to the capture of a single frame or a single point cloud. A scan pattern 200 may scan across any suitable field of regard (FOR) having any suitable horizontal FOR (FOR_{H}) and any suitable vertical FOR (FOR_{V}). For example, a scan pattern 200 may have a field of regard represented by angular dimensions (e.g., FOR_{H}×FOR_{V}) 40° x30°, 90°×40°, or 120°×20°. As another example, a scan pattern 200 may have a FOR_{H} greater than or equal to 10°, 25°, 30°, 40°, 60°, 90°, or 120°. As another example, a scan pattern 200 may have a FOR_{V} greater than or equal to 2°, 5°, 10°, 15°, 20°, 30°, or 45°.

In the example of FIG. 2, reference line 220 represents a center of the field of regard of scan pattern 200. A reference line 220 may have any suitable orientation, such as for example, a horizontal angle of 0° (e.g., reference line 220 may be oriented straight ahead) and a vertical angle of 0° (e.g., reference line 220 may have an inclination of) 0°, or reference line 220 may have a non-zero horizontal angle or a non-zero inclination (e.g., a vertical angle of +10° or) −10°. In FIG. 2, if the scan pattern 200 has a 60°×15° field of regard, then scan pattern 200 covers a ±30° horizontal range with respect to reference line 220 and a ±7.5° vertical range with respect to reference line 220. Additionally, optical beam 125 in FIG. 2 has an orientation of approximately −15° horizontal and +3° vertical with respect to reference line 220. Optical beam 125 may be referred to as having an azimuth of −15° and an altitude of +3° relative to reference line 220. An azimuth (which may be referred to as an azimuth angle) may represent a horizontal angle with respect to reference line 220, and an altitude (which may be referred to as an altitude angle, elevation, or elevation angle) may represent a vertical angle with respect to reference line 220.

A scan pattern 200 may include multiple pixels 210, and each pixel 210 may be associated with one or more optical pulses or one or more distance measurements. Additionally, a scan pattern 200 may include multiple scan lines 230, where each scan line represents one scan across at least part of a field of regard, and each scan line 230 may include multiple pixels 210. In FIG. 2, scan line 230 includes five pixels 210 and corresponds to an approximately horizontal scan across the FOR from right to left, as viewed from the lidar system 100. A complete cycle or traversal of a scan pattern 200 may include a total of Pₓ×P_{y} pixels 210 (e.g., a two-dimensional distribution of Pₓ by P_{y} pixels). As an example, scan pattern 200 may include a distribution with dimensions of approximately 100-2,000 pixels 210 along a horizontal direction and approximately 4-400 pixels 210 along a vertical direction. As another example, scan pattern 200 may include a distribution of 1,000 pixels 210 along the horizontal direction by 64 pixels 210 along the vertical direction (e.g., the frame size is 1000×64 pixels) for a total of 64,000 pixels per cycle of scan pattern 200.

A pixel 210 may refer to a data element that includes (i) distance information (e.g., a distance from a lidar system 100 to a target 130 from which an associated pulse of light was scattered) or (ii) an elevation angle and an azimuth angle associated with the pixel (e.g., the elevation and azimuth angles along which the associated pulse of light was emitted). Each pixel 210 may be associated with a distance (e.g., a distance to a portion of a target 130 from which an associated pulse of light was scattered) or one or more angular values. As an example, a pixel 210 may be associated with a distance value and two angular values (e.g., an azimuth and altitude) that represent the angular location of the pixel 210 with respect to the lidar system 100. A distance to a portion of target 130 may be determined based at least in part on a time-of-flight measurement for a corresponding pulse. An angular value (e.g., an azimuth or altitude) may correspond to an angle (e.g., relative to reference line 220) of output beam 125 (e.g., when a corresponding pulse is emitted from lidar system 100) or an angle of input beam 135 (e.g., when an input signal is received by lidar system 100). An angular value may be determined based at least in part on a position of a component of a scanner 120. As an example, an azimuth or altitude value associated with a pixel 210 may be determined from an angular position of one or more corresponding scan mirrors of the scanner 120.

FIG. 3 illustrates an example lidar system 100 with an example rotating polygon mirror 301. A scanner 120 may include a polygon mirror 301 configured to scan output beam 125 along a first direction and a scan mirror 302 configured to scan output beam 125 along a second direction different from the first direction (e.g., the first and second directions may be approximately orthogonal to one another, or the second direction may be oriented at any suitable non-zero angle with respect to the first direction). In the example of FIG. 3, scanner 120 includes two scan mirrors: (1) a polygon mirror 301 that rotates along the Ox direction and (2) a scan mirror 302 that oscillates back and forth along the Oy direction. The output beam 125 from light source 110, which passes alongside mirror 115, is reflected by reflecting surface 320 of scan mirror 302 and is then reflected by a reflecting surface (e.g., surface 320A, 320B, 320C, or 320D) of polygon mirror 301. Scattered light from a target 130 returns to the lidar system 100 as input beam 135. The input beam 135 reflects from polygon mirror 301, scan mirror 302, and mirror 115, which directs input beam 135 through focusing lens 330 and to the detector 340 of receiver 140. The detector 340 may be a PN photodiode, a PIN photodiode, an APD, a SPAD, or any other suitable detector. A reflecting surface 320 (which may be referred to as a reflective surface) may include a reflective metallic coating (e.g., gold, silver, or aluminum) or a reflective dielectric coating, and the reflecting surface 320 may have any suitable reflectivity R at an operating wavelength of the light source 110 (e.g., R may be greater than or equal to 70%, 80%, 90%, 95%, 98%, or 99%).

A polygon mirror 301 may be configured to rotate along a Ox or Oy direction and scan output beam 125 along a substantially horizontal or vertical direction, respectively. A rotation along a Ox direction may refer to a rotational motion of mirror 301 that results in output beam 125 scanning along a substantially horizontal direction. Similarly, a rotation along a Oy direction may refer to a rotational motion that results in output beam 125 scanning along a substantially vertical direction. In FIG. 3, mirror 301 is a polygon mirror that rotates along the Ox direction and scans output beam 125 along a substantially horizontal direction, and mirror 302 pivots along the Oy direction and scans output beam 125 along a substantially vertical direction. A polygon mirror 301 may be configured to scan output beam 125 along any suitable direction. As an example, a polygon mirror 301 may scan output beam 125 at any suitable angle with respect to a horizontal or vertical direction, such as for example, at an angle of approximately 0°, 10°, 20°, 30°, 45°, 60°, 70°, 80°, or 90° with respect to a horizontal or vertical direction.

A polygon mirror 301 may refer to a multi-sided object having reflective surfaces 320 on two or more of its sides or faces. As an example, a polygon mirror may include any suitable number of reflective faces (e.g., 2, 3, 4, 5, 6, 7, 8, or 10 faces), where each face includes a reflective surface 320. A polygon mirror 301 may have a cross-sectional shape of any suitable polygon, such as for example, a triangle (with three reflecting surfaces 320), square (with four reflecting surfaces 320), pentagon (with five reflecting surfaces 320), hexagon (with six reflecting surfaces 320), heptagon (with seven reflecting surfaces 320), or octagon (with eight reflecting surfaces 320). In FIG. 3, the polygon mirror 301 has a substantially square cross-sectional shape and four reflecting surfaces (320A, 320B, 320C, and 320D). The polygon mirror 301 in FIG. 3 may be referred to as a square mirror, a cube mirror, or a four-sided polygon mirror. In FIG. 3, the polygon mirror 301 may have a shape similar to a cube, cuboid, or rectangular prism. Additionally, the polygon mirror 301 may have a total of six sides, where four of the sides include faces with reflective surfaces (320A, 320B, 320C, and 320D).

A polygon mirror 301 may be continuously rotated in a clockwise or counterclockwise rotation direction about a rotation axis of the polygon mirror 301. The rotation axis may correspond to a line that is perpendicular to the plane of rotation of the polygon mirror 301 and that passes through the center of mass of the polygon mirror 301. In FIG. 3, the polygon mirror 301 rotates in the plane of the drawing, and the rotation axis of the polygon mirror 301 is perpendicular to the plane of the drawing. An electric motor may be configured to rotate a polygon mirror 301 at a substantially fixed frequency (e.g., a rotational frequency of approximately 1 Hz (or, 1 revolution per second), 10 Hz, 50 Hz, 100 Hz, 500 Hz, or 1,000 Hz). As an example, a polygon mirror 301 may be mechanically coupled to an electric motor (e.g., a synchronous electric motor) which is configured to spin the polygon mirror 301 at a rotational speed of approximately 160 Hz (or, 9600 revolutions per minute (RPM)).

In FIG. 3, the output beam 125 may be reflected sequentially from the reflective surfaces 320A, 320B, 320C, and 320D as the polygon mirror 301 is rotated. This results in the output beam 125 being scanned along a particular scan axis (e.g., a horizontal or vertical scan axis) to produce a sequence of scan lines, where each scan line corresponds to a reflection of the output beam 125 from one of the reflective surfaces of the polygon mirror 301. In FIG. 3, the output beam 125 reflects off of reflective surface 320A to produce one scan line. Then, as the polygon mirror 301 rotates, the output beam 125 reflects off of reflective surfaces 320B, 320C, and 320D to produce a second, third, and fourth respective scan line. A lidar system 100 may be configured so that the output beam 125 is first reflected from polygon mirror 301 and then from scan mirror 302 (or vice versa). As an example, an output beam 125 from light source 110 may first be directed to polygon mirror 301, where it is reflected by a reflective surface of the polygon mirror 301, and then the output beam 125 may be directed to scan mirror 302, where it is reflected by reflective surface 320 of the scan mirror 302. In the example of FIG. 3, the output beam 125 is reflected from the polygon mirror 301 and the scan mirror 302 in the reverse order. In FIG. 3, the output beam 125 from light source 110 is first directed to the scan mirror 302, where it is reflected by reflective surface 320, and then the output beam 125 is directed to the polygon mirror 301, where it is reflected by reflective surface 320A.

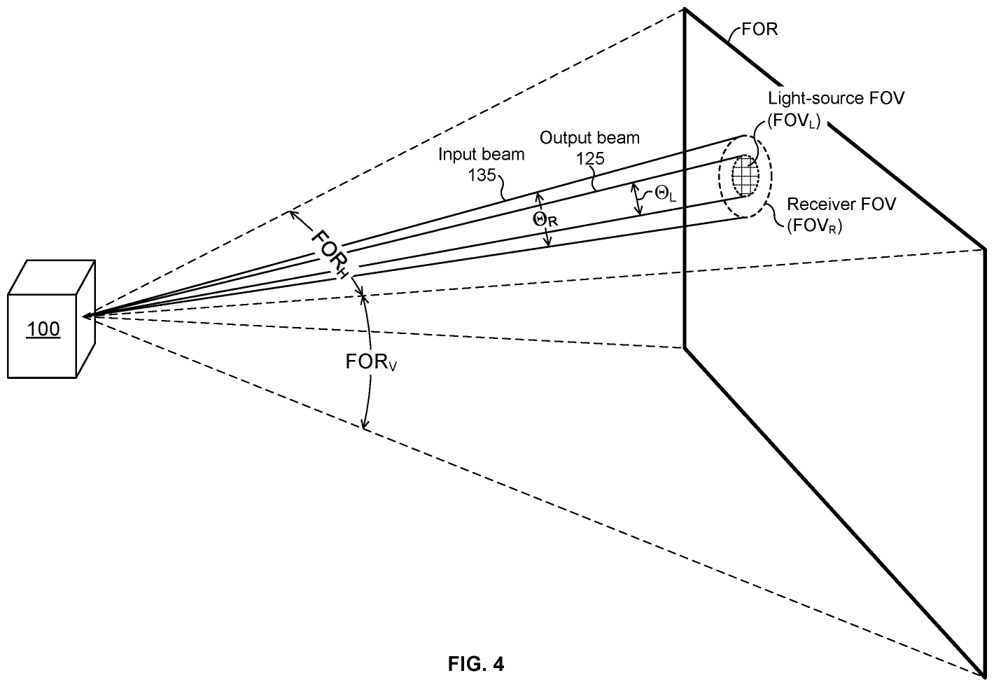

FIG. 4 illustrates an example light-source field of view (FOV_{L}) and receiver field of view (FOV_{R}) for a lidar system 100. A light source 110 of lidar system 100 may emit pulses of light as the FOV_{L} and FOV_{R} are scanned by scanner 120 across a field of regard (FOR). A light-source field of view may refer to an angular cone illuminated by the light source 110 at a particular instant of time. Similarly, a receiver field of view may refer to an angular cone over which the receiver 140 may receive or detect light at a particular instant of time, and any light outside the receiver field of view may not be received or detected. As an example, as the light-source field of view is scanned across a field of regard, a portion of a pulse of light emitted by the light source 110 may be sent downrange from lidar system 100, and the pulse of light may be sent in the direction that the FOV_{L} is pointing at the time the pulse is emitted. The pulse of light may scatter off a target 130, and the receiver 140 may receive and detect a portion of the scattered light that is directed along or contained within the FOV_{R}.

A scanner 120 may be configured to scan both a light-source field of view and a receiver field of view across a field of regard of the lidar system 100. Multiple pulses of light may be emitted and detected as the scanner 120 scans the FOV_{L} and FOV_{R} across the field of regard of the lidar system 100 while tracing out a scan pattern 200. The light-source field of view and the receiver field of view may be scanned synchronously with respect to one another, so that as the FOV_{L} is scanned across a scan pattern 200, the FOV_{R} follows substantially the same path at the same scanning speed. Additionally, the FOV_{L} and FOV_{R} may maintain the same relative position to one another as they are scanned across the field of regard. As an example, the FOV_{L} may be substantially overlapped with or centered inside the FOV_{R} (as illustrated in FIG. 4), and this relative positioning between FOV_{L} and FOV_{R} may be maintained throughout a scan. As another example, the FOV_{R} may lag behind the FOV_{L} by a particular, fixed amount throughout a scan (e.g., the FOV_{R} may be offset from the FOV_{L} in a direction opposite the scan direction).

An output beam of light 125 emitted by light source 110 may be a collimated optical beam having any suitable beam divergence, such as for example, a full-angle beam divergence Θ_{L} of approximately 0.5 to 10 milliradians (mrad). A divergence Θ_{L} of output beam 125 (which may be referred to as an angular size of the output beam) may correspond to an angular measure of an increase in beam size (e.g., a beam radius or beam diameter) as output beam 125 travels away from light source 110 or lidar system 100. An output beam 125 may have a substantially circular cross section with a beam divergence characterized by a single divergence value. As an example, an output beam 125 with a circular cross section and a full-angle beam divergence Θ_{L} of 2 mrad may have a beam diameter or spot size of approximately 20 cm at a distance of 100 m from lidar system 100. An output beam 125 may have a substantially elliptical cross section characterized by two divergence values. As an example, output beam 125 may have a fast axis and a slow axis, where the fast-axis divergence is greater than the slow-axis divergence. As another example, output beam 125 may be an elliptical beam with a fast-axis divergence of 4 mrad and a slow-axis divergence of 2 mrad.

The angular size Θ_{R} of a FOV_{R} may correspond to an angle over which the receiver 140 may receive and detect light. The receiver field of view may be any suitable size relative to the light-source field of view. As an example, the receiver field of view may be smaller than, substantially the same size as, or larger than the angular size of the light-source field of view. The light-source field of view may have an angular size of less than or equal to 50 milliradians, and the receiver field of view may have an angular size of less than or equal to 50 milliradians. The FOV_{L} may have any suitable angular size Θ_{L}, such as for example, an angular size of approximately 0.1 mrad, 0.2 mrad, 0.5 mrad, 1 mrad, 1.5 mrad, 2 mrad, 3 mrad, 5 mrad, 10 mrad, 20 mrad, 40 mrad, or 50 mrad. Similarly, the FOV_{R} may have any suitable angular size Θ_{R}, such as for example, an angular size of approximately 0.1 mrad, 0.2 mrad, 0.5 mrad, 1 mrad, 1.5 mrad, 2 mrad, 3 mrad, 5 mrad, 10 mrad, 20 mrad, 40 mrad, or 50 mrad. The light-source field of view and the receiver field of view may have approximately equal angular sizes. As an example, Θ_{L} and Θ_{R} may both be approximately equal to 0.5 mrad, 1 mrad, or 2 mrad. Alternatively, the receiver field of view may be larger than the light-source field of view, or the light-source field of view may be larger than the receiver field of view. As an example, Θ_{L} may be approximately equal to 1 mrad, and Θ_{R} may be approximately equal to 2 mrad. As another example, Θ_{R} may be approximately L times larger than Θ_{L}, where L is any suitable factor, such as for example, 1.1, 1.2, 1.5, 2, 3, 5, or 10.

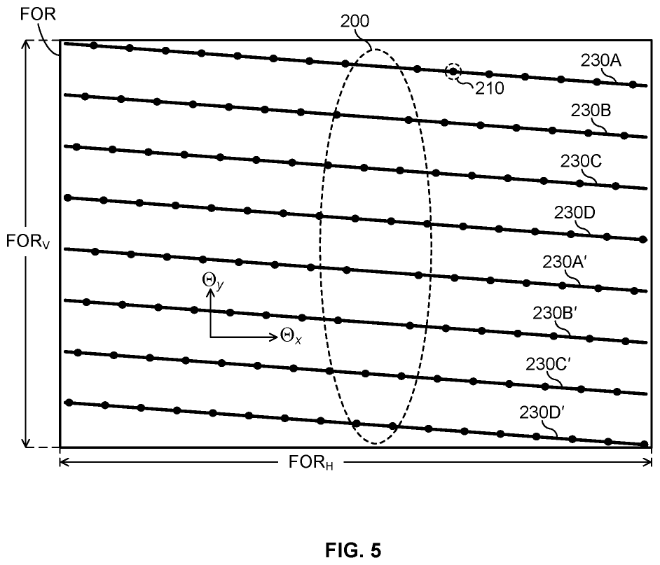

FIG. 5 illustrates an example unidirectional scan pattern 200 that includes multiple pixels 210 and multiple scan lines 230. A scan pattern 200 may include any suitable number of scan lines 230 (e.g., approximately 1, 2, 5, 10, 20, 50, 100, 500, or 1,000 scan lines), and each scan line 230 of a scan pattern 200 may include any suitable number of pixels 210 (e.g., 1, 2, 5, 10, 20, 50, 100, 200, 500, 1,000, 2,000, or 5,000 pixels). The scan pattern 200 illustrated in FIG. 5 includes eight scan lines 230, and each scan line 230 includes approximately 16 pixels 210. A scan pattern 200 in which the scan lines 230 are scanned in two directions (e.g., alternately scanning from right to left and then from left to right) may be referred to as a bidirectional scan pattern 200, and a scan pattern 200 in which the scan lines 230 are scanned in the same direction may be referred to as a unidirectional scan pattern 200. The scan pattern 200 in FIG. 2 may be referred to as a bidirectional scan pattern, and the scan pattern 200 in FIG. 5 may be referred to as a unidirectional scan pattern 200 where each scan line 230 travels across the FOR in substantially the same direction (e.g., approximately from left to right as viewed from the lidar system 100). Scan lines 230 of a unidirectional scan pattern 200 may be directed across a FOR in any suitable direction, such as for example, from left to right, from right to left, from top to bottom, from bottom to top, or at any suitable angle (e.g., at a 0°, 5°, 10°, 30°, or 45° angle) with respect to a horizontal or vertical axis. Each scan line 230 in a unidirectional scan pattern 200 may be a separate line that is not directly connected to a previous or subsequent scan line 230.

A unidirectional scan pattern 200 may be produced by a scanner 120 that includes a polygon mirror (e.g., polygon mirror 301 of FIG. 3), where each scan line 230 is associated with a particular reflective surface 320 of the polygon mirror. As an example, reflective surface 320A of polygon mirror 301 in FIG. 3 may produce scan line 230A in FIG. 5. Similarly, as the polygon mirror 301 rotates, reflective surfaces 320B, 320C, and 320D may successively produce scan lines 230B, 230C, and 230D, respectively. Additionally, for a subsequent revolution of the polygon mirror 301, the scan lines 230A′, 230B′, 230C′, and 230D′ may be successively produced by reflections of the output beam 125 from reflective surfaces 320A, 320B, 320C, and 320D, respectively. One full revolution of a N-sided polygon mirror may correspond to N successive scan lines 230 of a unidirectional scan pattern 200. As an example, the four scan lines 230A, 230B, 230C, and 230D in FIG. 5 may correspond to one full revolution of the four-sided polygon mirror 301 in FIG. 3. Additionally, a subsequent revolution of the polygon mirror 301 may produce the next four scan lines 230A′, 230B′, 230C′, and 230D′ in FIG. 5.

FIG. 6 illustrates an example light detection and ranging (lidar) system 100 including a blockage. Each of the components are like their counterparts in FIG. 1 unless otherwise described. In this example, the lidar system 100 includes a window 610. The window may be referred to as a light sensor window, sensor window, glass, or decorative glass.

Although depicted as included in, inside, or as part of the lidar system 100 here, the window 610 may be on the exterior of the lidar system in various embodiments. For example, the window may be integrated with a windshield of a vehicle. At least a portion of the window may become obscured due to a blockage 612, which may be debris such as road spray, weather elements such as rain or snow, contaminants, etc. These blockages may also be referred to as obscurants because they may obscure the view of at least a part of the target. The obscurant may be caused by various substances or objects. For example, road spray droplets typically contain a combination of absorption and scattering elements.

The disclosed techniques determine whether there is a blockage 612 on the window. In various embodiments, the blockage may be determined to be benign or malignant and/or with some degree of confidence. The blockage refers to any obscurant on a window. Emitted or returned beams may or may not pass through the blockage and may be severely attenuated by the blockage. If the lidar is installed in the exterior of the vehicle, the obscurant may be on the window 610 of the lidar system as shown. If the lidar system is installed in the interior of a vehicle and directed towards the windshield to emit beams of light through the windshield, the obscurant may be on a windshield of the vehicle.

In this example, there is a blockage 612 within the upper output beam transmit field of view. Even a very small obscurant may affect many rays, e.g., particularly if there is a relatively small azimuth pitch and a relatively large beam size. Here, an output beam 625 is emitted towards target 130, and the corresponding return beam 635 is received. However, the blockage 612 may affect the signal properties of the input beam B. For example, any scattered reflection returns are below a detection threshold of a receiver of the lidar system or otherwise reported as a blockage by firmware as further described herein.

Obscurants cause point cloud degradation. As used herein, “point cloud degradation” refers to immediate or potential negative impact on decision-making algorithms that use the point cloud. For example, a point cloud degradation budget may be established and maintained. The budget refers to an amount of degradation that is tolerated before the point cloud becomes unusable. Being able to distinguish between immediate and potential failures helps to more accurately make an accounting of the point cloud degradation budget. By way of a non-limiting example, decision-making algorithms include planning and control processes as well as object detection and classification processes. The ability to clearly determine what is surrounding the lidar system (e.g., the road in the context of a vehicle) impacts planning and controls processes because it may affect path planning and constraints for vehicle actuation. Similarly, detection and classification processes perform better with a higher quality point cloud. A point cloud that is degraded may cause the detection and classification processes to be unable to accurately and efficiently detect or classify an object.

In various embodiments, point cloud degradation may be determined as follows. A quantification of whether the number of beams required to detect and classify an object is sufficient may be made based on a projection on the window. A predetermined number or percentage may be defined. For example, if decision-making algorithms need at least 50% of the total beams to be low blockage to be able to correctly make decisions (e.g., the remainder may be high blockage or belonging to a no return cluster due to blockage or noise), this may be specified via setting a value of the predetermined number/percentage. In this example, a point cloud would be considered unusable (e.g., 100% degraded) if 50% or less of the return beams are received with low blockage in any bounding box scan across a reasonable field of view.

The window 610 (sometimes referred to as “decorative glass”) of the lidar, when blocked with a substance, generally creates sufficient back scatter onto the receiver to be able to measure some level of blockage. For example, firmware determines that there is a blockage based on the receiver (e.g., photodiodes) detecting backscatter. Beams that are emitted have an associated blockage level.

An obscurant may be a scatterer or an absorber, or a combination of both, e.g., partially scattering and partially absorbing. Blockages may be classified as scattering blockages or absorbing blockages. A scatterer, such as a smudge of dirt, reflects the outgoing photons back towards the receiver. Typically, a scattering obscurant causes a weak outgoing beam and a detectable, strong return. A scattering blockage may cause partial returns because it does not get absorbed by the operating wavelength. An absorber, such as a droplet of clean water, transforms photons into heat and backscattering tends to be minimal. Typically, an absorbing obscurant causes a weak outgoing beam and a regular return. An absorbing blockage causes empty (or no) returns. The emitted beam's photons are largely absorbed due to the absorbing blockage with little to no backscatter.

Conventionally, an absorbing obscurant cannot be detected based on observed backscatter. Correspondingly, conventional techniques typically cannot determine a cause of the blockage and whether the blockage is benign or malignant with respect to subsequent decision-making processes. For example, a benign blockage is free space such as the sky or a puddle on the ground that causes photons to be absorbed so that no back scattered signal is received by the sensor. Sometimes, a benign blockage is not actually a blockage because the empty rays/no returns are due to loss in the external environment. Nevertheless, any cause of empty rays that is not a malignant blockage is referred to as a “benign blockage.” A malignant blockage is an obscurant on the window such as dirty water spray, rain spray/droplets sufficiently small in size to the cause the backscatter, or the like. The disclosed techniques can detect non-purely absorbing obscurants and/or a cause or nature (benign or malignant) of a blockage by analyzing returns as further described herein.

A consequence of being unable to differentiate between a benign and malignant blockage is that there is no confidence of whether there is an absorbing blockage on a window. If a lidar system is blocked by an absorbing blockage limiting a field of regard or field of view, then the partial visibility is detrimental to any downstream decision-making processes and may even cause safety concerns. For example, a blockage on the window causes a degradation of a point cloud (as compared with a previous point cloud prior to an existence of the blockage on the window). Thus, the blockage on the window decreases performance of a consumer of the point cloud. For example, time-of-flight calculations or decision-making algorithms that use a degraded point cloud are less accurate or can make bad decisions.

FIG. 7 is a flow diagram illustrating an embodiment of a process for determining a lidar blockage. This process may be implemented on or by the system of FIG. 1 or the processor 1410 of FIG. 14.

In the example shown, the process begins by emitting an output beam comprising pulses of light through a window (700). The output beam may be emitted in the same manner as the examples described with respect to FIGS. 1-6. For example, 1000 beams are emitted 64 times, totaling 64,000 beams.

The process scans the output beam across a field of regard (702). As further described herein with respect to FIGS. 1-6, for each emitted beam, a return signal is received. The signal may indicate whether a return (a pulse of light) is received. If nothing is received, this is referred to as an “empty ray.” The signal may also indicate a blockage level, as further described herein.

The process detects, through the window, received pulses of light corresponding to scattered reflection returns of a first part of the emitted pulses of light, wherein scattered reflection returns, if any, of a second part of the emitted pulses of light are below a detection threshold (704). In various embodiments, the detection threshold is a minimum energy level that causes a receiver such as receiver 140 of FIG. 1 to detect a pulse of light. At least a portion of the emitted pulses (including empty rays) includes various signal properties such as whether this is an empty ray, and an associated blockage level. The blockage level is based on backscatter exceeding a threshold as measured by a photodiode, as described with respect to FIG. 6. For example, the blockage level may be a value that falls into one of several bins. By way of non-limiting example, the blockage level is a value between zero and 15.

The process determines whether at least a portion of the second part of the emitted pulses corresponds to a blockage on the window (706). In various embodiments, the blockage on the window includes an absorbing blockage that causes at least some backscatter. Some examples of absorbing blockages are described with respect to FIG. 6. Unlike conventional techniques that are unable to differentiate an absorbing blockage from free space loss, the disclosed techniques determine whether there is a blockage on the window with an associated level of confidence. This improves downstream processes such as time-of-flight calculations or decision making algorithms because those processes if informed of portions of point clouds that correspond to the blockage may then ignore or give a lower weight to those portions of the point clouds.

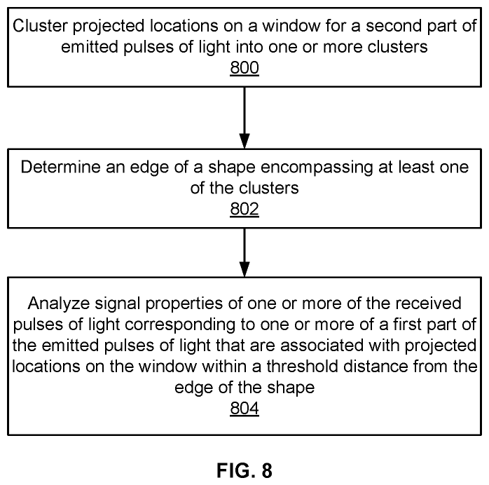

As further described with respect to FIG. 8, the process determines whether there is a blockage on the window by passing the second part of the emitted pulses to a clustering algorithm, determining a representative blockage level (also called the cluster blockage level) for each cluster, and if the representative blockage level exceeds a pre-determined threshold, then the blockage is likely a particular type of blockage, e.g., a non-purely absorbing blockage.

In various embodiments, the process optionally determines that at least a portion of the second part of the emitted pulses of light is caused by a factor in an environment independent of the blockage on the window. These factors may indicate that the blockage is benign. For example, the process determines that at least a portion of the second part of the emitted pulses of light is caused by free space loss.

In various embodiments, the process optionally outputs information associated with the determined blockage such as an indication or recommendation of the blockage on the window along with a confidence level. The indication or recommendation may be associated with the projected locations corresponding to the blockage on the window. The information may be provided in a variety of ways, such as providing a notification indicating the nature of the blockage (benign or malignant), only providing a notification if a blockage is determined to be malignant, etc. For example, the process determines, with a high level of confidence, not to trust beams that are in a particular region of the point cloud because the cause is more likely to be a blockage on the window rather than free space. A threshold level of confidence may be set to cause the recommendation to be made. The recommendation to disregard a particular region of the point cloud and associated level of confidence may be output. The process may output un-clustered noise points.

The disclosed techniques may be applied on multiple frames. In other words, determining whether at least a portion of the second part of the emitted pulses of light corresponds to a blockage on the window (706) is based at least on a plurality of frames. The process of FIG. 7 may be performed over time for a plurality of frames, e.g., in a temporal fashion. An advantage of considering multiple frames is that the confidence in the determination of the blockage is increased. For example, performing the process for a single frame may take around 100 milliseconds. In various embodiments, a processing time threshold may be set and a plurality of frames is processed within the time threshold to balance latency with increased confidence.

When considering multiple frames, the persistence of a particular point or set of points may be considered. That is, determining whether at least a portion of the second part of the emitted pulses of light corresponds to a blockage on the window (706) is based at least on a persistence of the projected locations across the plurality of frames. For example, the lidar system 100 of FIG. 1 may include an inertial measurement unit (IMU) or obtain IMU data from an external device (e.g., a vehicle in which the lidar is installed). The IMU measures and reports angular rate and specific force/acceleration experienced by an associated object. The IMU data may be used to determine whether empty rays are persisting over time/across frames. This indicates a blockage on the window. If the IMU data indicates that the empty ray is low or a cluster changes location, then the loss is less likely due to a blockage on the decorative glass of the sensor and more likely to be caused by a factor in the environment such as a puddle on the ground, sky, glass pane, etc.

FIG. 8 is a flow diagram illustrating an embodiment of a process for determining whether emitted pulses correspond to a blockage on a window. This process may be implemented on or by a controller 150 of FIG. 1 or the processor 1410 of FIG. 14. The process may be performed as part of another process, e.g., 706 of FIG. 7.

In the example shown, the process begins by clustering projected locations on a window for a second part of the emitted pulses into one or more clusters (800). In various embodiments, clustering the projected locations on the window includes using density-based spatial clustering of applications with noise (DBSCAN) to identify clusters. DBSCAN identifies an optimal number of clusters. This example is merely exemplary and not intended to be limiting as other types of clustering methods may be used.

Examples of the window and the second part of the emitted pulses are described in FIG. 6. Various clustering algorithms or models may be used. An example of a clustering model is density-based spatial clustering of applications with noise (DBSCAN), which identifies groups of datapoints that are close to nearby neighbors without requiring the number of clusters to be specified.

The process determines an edge of a shape encompassing at least one of the clusters (802). A concave hull is generated by obtaining the edge points of the clusters. Edge points refer to a point where visibility begins. The process determines the blockage level for those edge points, which may be reported by firmware.

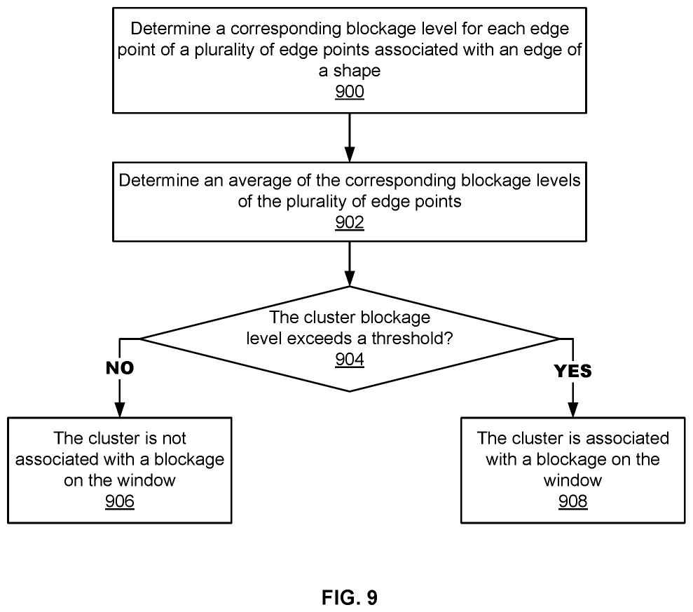

The process analyzes signal properties of one or more of the received pulses of light corresponding to one or more of a first part of the emitted pulses of light that are associated with projected locations on the window within a threshold distance from the edge of the shape (804). After projection (e.g., polar or cartesian) on the window, the hulls of the cluster of beas that results in no returns is traversed. For each beam on the hull, a nearest neighbor search is carried out to find beams that do report a blockage and of these, the beam with a threshold (e.g., p-th percentile) blockage value is used as the associated blockage with that beam. After traversing the hull, those blockages above the threshold value are used (e.g., averaged) to determine an affiliated blockage level of the cluster as further described herein with respect to FIG. 9. The affiliated blockage level may indicate that the blockage is benign or malignant.

Suppose the lidar is currently scanning open skies. The process may identify a cluster where the emitted beams were sent to free space and the returns are empty rays because there are no objects in the sky. The process detects the cluster of sky, analyzing the periphery (edge) of the cluster including by determining the blockage level at each edge point. For each edge point, the process searches within a particular radius (a pre-definable threshold distance), and determines an average blockage value.

In various embodiments, the process excludes at least one of the one or more of the received pulses of light within the threshold distance having a blockage level below a threshold blockage level. This causes outlier edge points to be excluded when determining a representative cluster blockage level. For example, only those edge points having blockage levels within the 90^{th} percentile are used to determine the average.

FIG. 9 is a flow diagram illustrating an embodiment of a process for analyzing signal properties of one or more of the received pulses of light. This process may be implemented on or by a controller 150 of FIG. 1 or the 1410 of FIG. 14. The process may be performed as part of another process, e.g., 804 of FIG. 8.

The process begins by determining a corresponding blockage level for each edge point of a plurality of edge points associated with the edge of the shape (900). The blockage level may be reported by firmware. In various embodiments, the blockage level is binned into one of several bins such as a value from zero to 15.

In various embodiments, a data structure such as a K-Dimensional (K-D) tree may be used to facilitate clustering and analysis. A data structure such as a K-D tree supports fast access and searching of neighboring points. For example, prior to clustering the projected locations on the window for the second part of the emitted pulses of light into one or more clusters (800), a K-D tree is populated with a subset of the one or more of the received pulses of light, each member of the subset having a blockage level greater than a pre-defined threshold (e.g., the threshold=0). The K-D tree may be populated by the index of points that have blockage levels >0. The K-D tree is searchable to determine neighbors of a search point. For example, when the edge points of a non-return cluster is traversed, a look up of nearest neighbors of the search point (each edge point) is performed using the K-D Tree.

The process creates a concave hull (e.g., a shape with an edge) around the cluster for each cluster. For each edge point (also referred to as “point on the hull”) of the cluster, the process searches the K-D tree for the corresponding blockage level.

The process determines an average of the corresponding blockage levels of the plurality of edge points (902). The process finds a representative value for each edge point in the cluster, and averages the values to assign a cluster blockage level for the cluster. The analysis of the signal properties of the one or more of the received pulses of light corresponding to one or more of the first part of the emitted pulses of light that are associated with projected locations on the window within a threshold distance from the edge of the shape includes querying the K-D tree to find neighbors within the threshold distance. In various embodiments, the averaging of the nearest neighbor points includes one or more points outside of region with no returns. For example, the process determines and stores a blockage level by finding all of the points within a radius. For example, if the projection is cartesian, then the radius is 1 mm. If the projection is in azimuth/elevation, then the radius is in radians. The process may discard those points/values that are outliers such as those that exceed the 90th percentile. The process assigns a cluster blockage level to the cluster associated with the edge of the shape.

In various embodiments, points with a blockage level greater than 0 may be stored in a K-D Tree to facilitate fast searching for those neighbors (with blockage levels >0) of the non-return/empty ray points. The search results, e.g., non-return/empty ray points, may then be affiliated with a blockage level using the blockage level of the p-th percentile over the found neighbors. After each non-return/empty ray is associated with a blockage level, all of the associated blockage levels of the non-return/empty ray points on the hull of that particular cluster are averaged (e.g., mean) to compute an affiliated blockage level of the cluster.

The process determines whether the cluster blockage level exceeds a threshold (904). Referring to the example described with respect to 902, the computed affiliated blockage level is then compared with the threshold to determine if the cluster is marked as benign or malignant. If that cluster blockage level is below a pre-determined threshold, the process determines that the empty ray cluster is benign. For example, the cause may be a puddle in the road. A subsequent path finding algorithm may be informed about the corresponding region in the point cloud. However, if the cluster blockage level is above a threshold, then the output is that there is likely an obscurant on the glass and the corresponding obscured area in the point cloud is not to be trusted.

In response to a determination that the assigned cluster blockage level of the cluster is not above a cluster blockage level threshold, the process determines that the cluster is not associated with the blockage on the window (906). If the average blockage value is low (e.g., 3 or less), then this indicates that the empty ray cluster is benign. For example, the blockage is due to open sky or a puddle on the ground where the light beams were absorbed and low/no returns were detected.

Otherwise, in response to a determination that the assigned cluster blockage level of the cluster is above a cluster blockage level threshold, the process determines that the cluster is associated with the blockage on the window (908). If the average blockage value is high (e.g., 8 or higher) then the process determines that this is a malignant blockage. Malignant blockages may be caused by obscurants such as dirty spray. This insight may be output and may be helpful for downstream processes such as path planning, machine learning object detection, semantic segmentation, etc. as further described herein.

Being able to classify “no returns” as being due to a blockage on the window vs. due to free space loss is advantageous. “No returns” due to free space loss may be considered “non relevant” or “benign,” while blockages due to a blockage on the window can be addressed by removing the blockage or processing that region of the point cloud differently from how the rest of the point cloud is processed.

FIG. 10 shows an example of a point cloud corresponding to a clean sensor. In this example, the darkness of the points represents the distance to a target. There are various regions (white) with low/no returns. In this example, these empty rays are benign because they are not caused by a blockage on the window. For example, region 1002 indicates a group of empty returns. The group of empty returns is a marking on the plot of points where beams were sent out but the received return is either below a threshold or no return was received. This may be due to various causes such as open sky or glass/windows on a building.

FIG. 11 shows an example of a point cloud corresponding to a sensor with a blockage. In this example the empty rays are malignant because they are caused by a blockage on the window. Regions 1110 and 1112 appear to have low/no returns.

The point clouds in both FIGS. 10 and 11 are degraded because there are blockages. However, when considering the point clouds alone, it is difficult to determine whether the blockages have been caused by benign or malignant empty rays. The disclosed techniques may be applied to determine whether there is actually a blockage on the lidar and/or the nature of the blockage. For example, a cluster blockage level is assigned to each cluster (1110 and 1112). The cluster blockage level is compared with a threshold value. Being equal to or above the threshold value indicates that the blockages are due to a malignant cause (e.g., a blockage on the window of the lidar system), while being below the threshold value indicates that the blockages are due to a benign cause (e.g., a puddle, open sky, or glass on a building). If the blockages are determined to be due to a blockage on the window such as dirty spray, then the point cloud may be output along with an indication that a particular region/cluster of projected locations is likely due to a blockage. A user may then take action such as cleaning the lidar window to remove the blockage. Downstream processes may use the point cloud and ignore or de-prioritize the indicated regions as they are not trustworthy.

In addition to the examples described, another possible scenario is that the empty rays are due to a combination or a benign cause (e.g., sky) and a malignant cause (e.g., dirty water spray obscurant on a window of a lidar system). If the dirty water spray is minor or small in volume, this would cause the disclosed techniques to determine a relatively low (below a threshold) value for the cluster blockage level and attribute the empty rays to a benign cause. However, if the dirty water spray is large in volume, this may cause the cluster blockage level to exceed the threshold. Consequently, the blockage would be considered malignant, which is a false positive. However, this determination is appropriate because the lidar system window is sufficiently dirty/blocked that taking an action to ameliorate the situation (e.g., wait or clean the window) is proper.

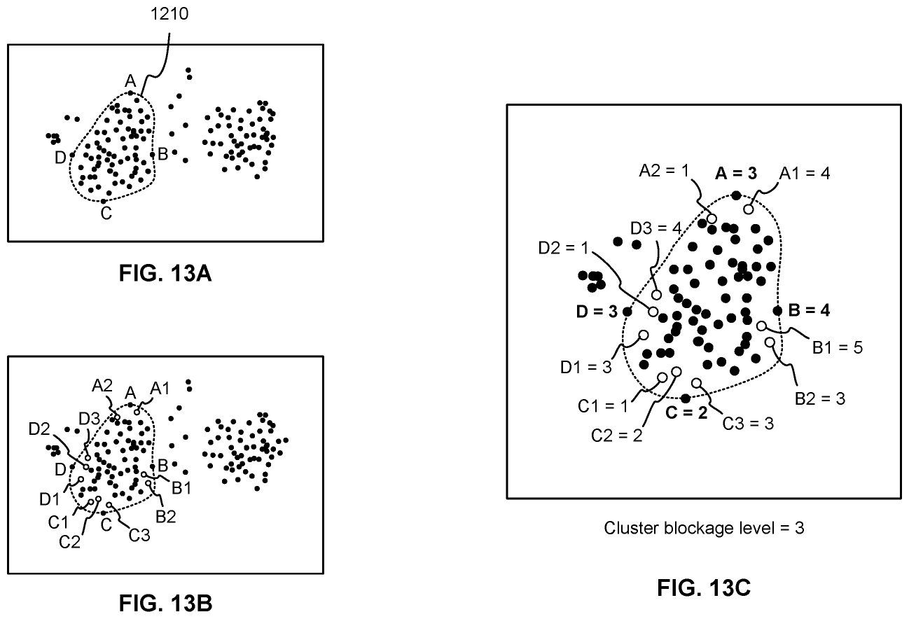

FIG. 12 shows an example of a blockage map corresponding to a sensor with a blockage. This blockage map corresponds to the point cloud of FIG. 11. This blockage map shows the blockage levels corresponding to the points in the point cloud. In the areas with no returns (e.g., region 1210 and 1212), the blockage level is high. Each of these clusters may be identified and processed using the disclosed techniques to determine whether the cause of the blockage is malignant (e.g., a blockage on the window of the lidar system) or benign (e.g., not a blockage on the window of the lidar system). The manner in which the blockage map shown here may be processed is further described with respect to the following figures. The processes of FIGS. 7-9 will be explained with the aid of FIGS. 13A-13C, which show how the blockage map of FIG. 12 is processed.

FIG. 13A shows an example of a blockage map including an identified concave hull corresponding to a sensor with a blockage. The blockage map corresponds to a projection of points/locations of emitted pulses of light onto a window (e.g., windshield). In this example, the blockage map corresponds to those emitted pulses of light that are below a detection threshold. Each of the points in FIG. 13A corresponds to a “no return.” The disclosed techniques may be applied to determine a nature or cause (e.g., a blockage on the window vs. free space loss) of the “no return.”

In this example, projected locations have been clustered into one or more clusters (e.g., 800 of FIG. 8). A first cluster 1310 (sometimes called a concave hull) is indicated by the dashed line. In this example, the edge of the shape 1310 includes four points, A, B, C, and D (e.g., 802 of FIG. 8). Signal properties of these points and near neighbors (e.g., those projected locations that are within a threshold distance from the edge of the shape) may be further analyzed as follows (e.g., 804 of FIG. 8).

FIG. 13B shows an example of a blockage map including identified neighbors of edge points in a concave hull corresponding to a sensor with a blockage. By considering the values of neighbors of an edge point, the process determines whether there is a sharp drop-off at the edge of the shape. If there is a sharp drop-off in blockage levels, then the blockage is likely malignant. Conversely, if there is not a sharp drop-off, then the blockage is likely benign. For example, the neighbors of point A are A1 and A2; the neighbors of point B are B1 and B2; the neighbors of point C are C1, C2, and C3; and the neighbors of point D are D1, D2, and D3 because the neighbor points are within a pre-defined threshold (e.g., radial) distance. The associated blockage value of point A may be based on the values of A1 and A2; the value of point B may be based on the values of B1 and B2, etc. For example, the associated blockage value of point A may be computed by taking a p-th percentile of all neighbors within a radial distance. Each projected location has an associated blockage level, which is a numerical value that is based on comparing the energy of a return pulse with the energy of an outgoing pulse. The blockage level may be reported by firmware.

FIG. 13C shows an example of a blockage map including a determined cluster blockage level of a concave hull corresponding to a sensor with a blockage. The cluster blockage level, sometimes referred to as an affiliated blockage level, is a value that is assigned to a particular cluster and representative of that cluster. In this example, a value of each of the neighbors of points A-D is shown. In this example, the value of each of the points A-D is the average of the values of their respective neighbors. As described herein, the data may be stored in a K-D tree and the values may be found by querying the K-D tree to find neighbors within a threshold distance. Thus, the value of point A is 3, the value of point B is 4, the value of point C is 2, and the value of point D is 3 (e.g., 900 of FIG. 9). The cluster blockage level in this example is determined by taking the average of the edge points, which is 3 (e.g., 902 of FIG. 9). Thus, the cluster blockage level of cluster 1310 is 3. Although this example shows an instance where the neighbors used to obtain the cluster blockage level are all within the region of no returns 1210, this is not intended to be limiting as it is possible to consider neighbors outside of the region. In other words, the averaging of the nearest neighbor points may include one or more points outside of region with no returns 1210.

In various embodiments, one or more edge points may be excluded. For example, only those edge points having blockage levels within the p-th percentile (e.g., 90^{th} percentile) are used to determine the cluster blockage level. Suppose the value of point B is outside the 90^{th} percentile, then that value would be discarded and not used for determining the cluster blockage level. Using the p-the percentile rather than the absolute maximum may be attractive because it filters out outliers.

The nature of the blockage (e.g., benign of malignant) may be determined by comparing the cluster blockage level with a threshold (e.g., 904 of FIG. 9). Suppose the threshold in this scenario is 4. Being above 4 indicates that there is a true blockage on the window, while being equal to or below 4 indicates that the “no returns” are due to free space loss or another benign cause. In this example, the cluster blockage level is 3, so the blockage is considered to be benign (e.g., 906 of FIG. 9).

FIG. 14 illustrates an example computer system 1400. FIG. 14 illustrates an example computer system 1400. One or more computer systems 1400 may perform one or more steps of one or more methods described or illustrated herein. One or more computer systems 1400 may provide functionality described or illustrated herein. Software running on one or more computer systems 1400 may perform one or more steps of one or more methods described or illustrated herein or may provide functionality described or illustrated herein. A computer system may be referred to as a processor, a controller, a computing device, a computing system, a computer, a general-purpose computer, or a data-processing apparatus. For example, controller 150 in FIG. 1 may be referred to or may include a computer system. Herein, reference to a computer system may encompass one or more computer systems, where appropriate.

Computer system 1400 may take any suitable physical form. As an example, computer system 1400 may be an embedded computer system, a system-on-chip (SOC), an application-specific integrated circuit (ASIC), a field-programmable gate array (FPGA), a single-board computer system (SBC), a desktop computer system, a laptop or notebook computer system, a mainframe, a mesh of computer systems, a server, a tablet computer system, or any suitable combination of two or more of these. As another example, all or part of computer system 1400 may be combined with, coupled to, or integrated into a variety of devices, including, but not limited to, a camera, camcorder, personal digital assistant (PDA), mobile telephone, smartphone, electronic reading device (e.g., an e-reader), game console, smart watch, clock, calculator, television monitor, flat-panel display, computer monitor, vehicle display (e.g., odometer display or dashboard display), vehicle navigation system, lidar system, ADAS, autonomous vehicle, autonomous-vehicle driving system, cockpit control, camera view display (e.g., display of a rear-view camera in a vehicle), eyewear, or head-mounted display. Where appropriate, computer system 1400 may include one or more computer systems 1400; be unitary or distributed; span multiple locations; span multiple machines; span multiple data centers; or reside in a cloud, which may include one or more cloud components in one or more networks. Where appropriate, one or more computer systems 1400 may perform without substantial spatial or temporal limitation one or more steps of one or more methods described or illustrated herein. As an example, one or more computer systems 1400 may perform in real time or in batch mode one or more steps of one or more methods described or illustrated herein. One or more computer systems 1400 may perform at different times or at different locations one or more steps of one or more methods described or illustrated herein, where appropriate.

As illustrated in the example of FIG. 14, computer system 1400 may include a processor 1410, memory 1420, storage 1430, an input/output (I/O) interface 1440, a communication interface 1450, or a bus 1460. Computer system 1400 may include any suitable number of any suitable components in any suitable arrangement.

Processor 1410 may include hardware for executing instructions, such as those making up a computer program. As an example, to execute instructions, processor 1410 may retrieve (or fetch) the instructions from an internal register, an internal cache, memory 1420, or storage 1430; decode and execute them; and then write one or more results to an internal register, an internal cache, memory 1420, or storage 1430. A processor 1410 may include one or more internal caches for data, instructions, or addresses. Processor 1410 may include any suitable number of any suitable internal caches, where appropriate. As an example, processor 1410 may include one or more instruction caches, one or more data caches, or one or more translation lookaside buffers (TLBs). Instructions in the instruction caches may be copies of instructions in memory 1420 or storage 1430, and the instruction caches may speed up retrieval of those instructions by processor 1410. Data in the data caches may be copies of data in memory 1420 or storage 1430 for instructions executing at processor 1410 to operate on; the results of previous instructions executed at processor 1410 for access by subsequent instructions executing at processor 1410 or for writing to memory 1420 or storage 1430; or other suitable data. The data caches may speed up read or write operations by processor 1410. The TLBs may speed up virtual-address translation for processor 1410. Processor 1410 may include one or more internal registers for data, instructions, or addresses. Processor 1410 may include any suitable number of any suitable internal registers, where appropriate. Where appropriate, processor 1410 may include one or more arithmetic logic units (ALUs); may be a multi-core processor; or may include one or more processors 1410.

Memory 1420 may include main memory for storing instructions for processor 1410 to execute or data for processor 1410 to operate on. As an example, computer system 1400 may load instructions from storage 1430 or another source (such as, for example, another computer system 1400) to memory 1420. Processor 1410 may then load the instructions from memory 1420 to an internal register or internal cache. To execute the instructions, processor 1410 may retrieve the instructions from the internal register or internal cache and decode them. During or after execution of the instructions, processor 1410 may write one or more results (which may be intermediate or final results) to the internal register or internal cache. Processor 1410 may then write one or more of those results to memory 1420. One or more memory buses (which may each include an address bus and a data bus) may couple processor 1410 to memory 1420. Bus 1460 may include one or more memory buses. One or more memory management units (MMUs) may reside between processor 1410 and memory 1420 and facilitate accesses to memory 1420 requested by processor 1410. Memory 1420 may include random access memory (RAM). This RAM may be volatile memory, where appropriate. Where appropriate, this RAM may be dynamic RAM (DRAM) or static RAM (SRAM). Memory 1420 may include one or more memories 1420, where appropriate.

Storage 1430 may include mass storage for data or instructions. As an example, storage 1430 may include a hard disk drive (HDD), a floppy disk drive, flash memory, an optical disc, a magneto-optical disc, magnetic tape, or a Universal Serial Bus (USB) drive or a combination of two or more of these. Storage 1430 may include removable or non-removable (or fixed) media, where appropriate. Storage 1430 may be internal or external to computer system 1400, where appropriate. Storage 1430 may be non-volatile, solid-state memory. Storage 1430 may include read-only memory (ROM). Where appropriate, this ROM may be mask ROM (MROM), programmable ROM (PROM), erasable PROM (EPROM), electrically erasable PROM (EEPROM), flash memory, or a combination of two or more of these. Storage 1430 may include one or more storage control units facilitating communication between processor 1410 and storage 1430, where appropriate. Where appropriate, storage 1430 may include one or more storages 1430.

I/O interface 1440 may include hardware, software, or both, providing one or more interfaces for communication between computer system 1400 and one or more I/O devices. Computer system 1400 may include one or more of these I/O devices, where appropriate. One or more of these I/O devices may enable communication between a person and computer system 1400. As an example, an I/O device may include a keyboard, keypad, microphone, monitor, mouse, printer, scanner, speaker, camera, stylus, tablet, touch screen, trackball, another suitable I/O device, or any suitable combination of two or more of these. An I/O device may include one or more sensors. Where appropriate, I/O interface 1440 may include one or more device or software drivers enabling processor 1410 to drive one or more of these I/O devices. I/O interface 1440 may include one or more I/O interfaces 1440, where appropriate.

Communication interface 1450 may include hardware, software, or both providing one or more interfaces for communication (such as, for example, packet-based communication) between computer system 1400 and one or more other computer systems 1400 or one or more networks. As an example, communication interface 1450 may include a network interface controller (NIC) or network adapter for communicating with an Ethernet or other wire-based network or a wireless NIC (WNIC); a wireless adapter for communicating with a wireless network, such as a WI-FI network; or an optical transmitter (e.g., a laser or a light-emitting diode) or an optical receiver (e.g., a photodetector) for communicating using fiber-optic communication or free-space optical communication. Computer system 1400 may communicate with an ad hoc network, a personal area network (PAN), an in-vehicle network (IVN), a local area network (LAN), a wide area network (WAN), a metropolitan area network (MAN), or one or more portions of the Internet or a combination of two or more of these. One or more portions of one or more of these networks may be wired or wireless. As an example, computer system 1400 may communicate with a wireless PAN (WPAN) (such as, for example, a BLUETOOTH WPAN), a WI-FI network, a Worldwide Interoperability for Microwave Access (WiMAX) network, a cellular telephone network (such as, for example, a Global System for Mobile Communications (GSM) network), or other suitable wireless network or a combination of two or more of these. As another example, computer system 1400 may communicate using fiber-optic communication based on 100 Gigabit Ethernet (100 GbE), 10 Gigabit Ethernet (10 GbE), or Synchronous Optical Networking (SONET). Computer system 1400 may include any suitable communication interface 1450 for any of these networks, where appropriate. Communication interface 1450 may include one or more communication interfaces 1450, where appropriate.

Bus 1460 may include hardware, software, or both coupling components of computer system 1400 to each other. As an example, bus 1460 may include an Accelerated Graphics Port (AGP) or other graphics bus, a controller area network (CAN) bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these. Bus 1460 may include one or more buses 1460, where appropriate.

Various modules, circuits, systems, methods, or algorithm steps described in connection with the implementations disclosed herein may be implemented as electronic hardware, computer software, or any suitable combination of hardware and software. Computer software (which may be referred to as software, computer-executable code, computer code, a computer program, computer instructions, or instructions) may be used to perform various functions described or illustrated herein, and computer software may be configured to be executed by or to control the operation of computer system 1400. As an example, computer software may include instructions configured to be executed by processor 1410. Owing to the interchangeability of hardware and software, the various illustrative logical blocks, modules, circuits, or algorithm steps have been described generally in terms of functionality. Whether such functionality is implemented in hardware, software, or a combination of hardware and software may depend upon the particular application or design constraints imposed on the overall system.

A computing device may be used to implement various modules, circuits, systems, methods, or algorithm steps disclosed herein. As an example, all or part of a module, circuit, system, method, or algorithm disclosed herein may be implemented or performed by a general-purpose single- or multi-chip processor, a digital signal processor (DSP), an ASIC, a FPGA, any other suitable programmable-logic device, discrete gate or transistor logic, discrete hardware components, or any suitable combination thereof. A general-purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

One or more implementations of the subject matter described herein may be implemented as one or more computer programs (e.g., one or more modules of computer-program instructions encoded or stored on a computer-readable non-transitory storage medium). As an example, the steps of a method or algorithm disclosed herein may be implemented in a processor-executable software module which may reside on a computer-readable non-transitory storage medium. A computer-readable non-transitory storage medium may include any suitable storage medium that may be used to store or transfer computer software and that may be accessed by a computer system. Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs (e.g., compact discs (CDs), CD-ROM, digital versatile discs (DVDs), Blu-ray discs, or laser discs), optical disc drives (ODDs), magneto-optical discs, magneto-optical drives, floppy diskettes, floppy disk drives (FDDs), magnetic tapes, flash memories, solid-state drives (SSDs), RAM, RAM-drives, ROM, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a light source configured to emit an output beam comprising pulses of light through a window;
a scanner configured to scan the output beam across a field of regard of the system;
a receiver configured to detect, through the window, received pulses of light corresponding to scattered reflection returns of a first part of the emitted pulses of light, wherein scattered reflection returns, if any, of a second part of the emitted pulses of light are below a detection threshold of the receiver; and
a processor configured to determine whether at least a portion of the second part of the emitted pulses of light corresponds to a blockage on the window including by being configured to:
cluster projected locations on the window for the second part of the emitted pulses of light into one or more clusters;
determine an edge of a shape encompassing at least one of the clusters; and
analyze signal properties of one or more of the received pulses of light corresponding to one or more of the first part of the emitted pulses of light that are associated with projected locations on the window within a threshold distance from the edge of the shape.

2. The system of claim 1, wherein the blockage on the window includes an absorbing blockage that causes at least some backscatter.

3. The system of claim 1, wherein the blockage on the window causes a degradation of a point cloud associated with the received pulses of light and the point cloud compared with a previous point cloud prior to an existence of the blockage on the window.

4. The system of claim 3, wherein the blockage on the window decreases performance of a consumer of the point cloud.

5. The system of claim 1, further comprising outputting a recommendation associated with the projected locations corresponding to the blockage on the window.

6. The system of claim 1, wherein the processor is further configured to determine that at least a portion of the second part of the emitted pulses of light is caused by free space loss.

7. The system of claim 1, wherein the processor is further configured to determine that at least a portion of the second part of the emitted pulses of light is caused by a factor in an environment independent of the blockage on the window.

8. The system of claim 1, wherein the clustering the projected locations on the window includes using density-based spatial clustering of applications with noise (DBSCAN) to identify clusters.

9. The system of claim 1, wherein the threshold distance from the edge of the shape is based at least on scan density.

10. The system of claim 1, wherein analyzing the signal properties of the one or more of the received pulses of light includes excluding at least one of the one or more of the received pulses of light within the threshold distance having a blockage level below a threshold blockage level.

11. The system of claim 1, wherein analyzing the signal properties of the one or more of the received pulses of light corresponding to the one or more of the first part of the emitted pulses of light that are associated with the projected locations on the window within the threshold distance from the edge of the shape includes:
determining a corresponding blockage level for each edge point of a plurality of edge points associated with the edge of the shape;
determining an average of the corresponding blockage levels of the plurality of edge points;
assigning a cluster blockage level to a cluster associated with the edge of the shape; and
in response to a determination that the assigned cluster blockage level of the cluster is above a cluster blockage level threshold, determining that the cluster is associated with the blockage on the window.

12. The system of claim 1, wherein analyzing the signal properties of the one or more of the received pulses of light corresponding to the one or more of the first part of the emitted pulses of light that are associated with the projected locations on the window within the threshold distance from the edge of the shape includes:
determining a corresponding blockage level for each edge point of a plurality of edge points associated with the edge of the shape;
determining an average of the corresponding blockage levels of the plurality of edge points;
assigning a cluster blockage level to the cluster associated with the edge of the shape; and
in response to a determination that the assigned cluster blockage level of the cluster is below a cluster blockage level threshold, determining that the cluster is not associated with the blockage on the window.

13. The system of claim 12, wherein the processor is further configured to, prior to the clustering the projected locations on the window for the second part of the emitted pulses of light into one or more clusters:
populate a K-Dimensional (K-D) tree with a subset of the one or more of the received pulses of light, each member of the subset having a blockage level greater than a pre-defined threshold level; and
the K-D tree is searchable to determine neighbors of a search point.

14. The system of claim 13, wherein analyzing the signal properties of the one or more of the received pulses of light corresponding to the one or more of the first part of the emitted pulses of light that are associated with the projected locations on the window within the threshold distance from the edge of the shape includes querying the K-D tree to find neighbors within the threshold distance.

15. The system of claim 1, wherein the processor is further configured to output an indication of the blockage on the window along with a confidence level.

16. The system of claim 1, wherein the processor is further configured to output an indication of a benign blockage on the window.

17. The system of claim 1, wherein the processor is further configured to output un-clustered noise points.

18. The system of claim 1, wherein determining whether at least a portion of the second part of the emitted pulses of light corresponds to a blockage on the window is based at least on a plurality of frames.

19. The system of claim 18, wherein determining whether at least a portion of the second part of the emitted pulses of light corresponds to a blockage on the window is based at least on a persistence of the projected locations across the plurality of frames.

20. A method, comprising:
emitting an output beam comprising pulses of light through a window;
scanning the output beam across a field of regard;
detecting, through the window, received pulses of light corresponding to scattered reflection returns of a first part of the emitted pulses of light, wherein scattered reflection returns, if any, of a second part of the emitted pulses of light are below a detection threshold; and
determining whether at least a portion of the second part of the emitted pulses of light corresponds to a blockage on the window including by:
clustering projected locations on the window for the second part of the emitted pulses of light into one or more clusters;
determining an edge of a shape encompassing at least one of the clusters; and
analyzing signal properties of one or more of the received pulses of light corresponding to one or more of the first part of the emitted pulses of light that are associated with projected locations on the window within a threshold distance from the edge of the shape.

21. A computer program product embodied in a non-transitory computer readable medium and comprising computer instructions for:
emitting an output beam comprising pulses of light through a window;
scanning the output beam across a field of regard;
detecting, through the window, received pulses of light corresponding to scattered reflection returns of a first part of the emitted pulses of light, wherein scattered reflection returns, if any, of a second part of the emitted pulses of light are below a detection threshold; and
determining whether at least a portion of the second part of the emitted pulses of light corresponds to a blockage on the window including by:
clustering projected locations on the window for the second part of the emitted pulses of light into one or more clusters;
determining an edge of a shape encompassing at least one of the clusters; and
analyzing signal properties of one or more of the received pulses of light corresponding to one or more of the first part of the emitted pulses of light that are associated with projected locations on the window within a threshold distance from the edge of the shape.
